(19) United States
(12) Patent Application Publication
(10) Pub. No.: US 2024/0314610 A1
(43) Pub. Date: Sep. 19, 2024

(54) COMMUNICATION APPARATUS AND COMMUNICATION METHOD FOR LOW COMPLEXITY WLAN SENSING

(71) Applicant: Panasonic Intellectual Property Corporation of America, Torrance, CA (US)

(72) Inventors: Rojan CHITRAKAR, Singapore (SG); Yoshio URABE, Nara (JP); Rajat PUSHKARNA, Singapore (SG)

(21) Appl. No.: 18/576,048

(22) PCT Filed: Jun. 15, 2022
(86) PCT No.: PCT/SG2022/050414

§ 371 Date: Jan. 2, 2024

(30) Foreign Application Priority Data
Jul. 30, 2021 (SG) 10202108368V
Aug. 2, 2021 (SG) 10202108443R
Aug. 20, 2021 (SG) 10202109124V

(51) Int. Cl. H04W 24/10; H04W 52/02; H04W 84/12

(52) U.S. Cl. CPC H04W 24/10; H04W 52/0216; H04W 84/12

(57) ABSTRACT

Communication devices and methods for low complexity WLAN sensing are provided. One exemplary embodiment provides a first communication apparatus comprising a receiver, which in operation, receives a measurement request frame from a second communication apparatus, the measurement request frame carrying a delayed response field indicating whether a delayed response is allowed: and a transmitter, which in operation, transmits a measurement Physical Protocol Data Unit (PPDU) to be used for channel measurements in response to the measurement request frame.

### RELATED APPLICATIONS

The present application claims priority to Singapore Patent Application Nos. 10202108368V and 10202108443R. Further, Singapore Patent Application No. 10202109124V is incorporated herein by reference.

### BACKGROUND

### 1. Technical Field

The present embodiments generally relate to communication apparatuses, and more particularly relate to methods and apparatuses for low complexity wireless local area network (WLAN) sensing.

### 2. Description of the Related Art

In the standardization of next generation wireless local area network (WLAN), new radio access technology having backward compatibilities with IEEE 802.11a/b/g/n/ac/ax technologies has been discussed in the IEEE 802.11 Working Group and is named 802.11 be Extremely High Throughput (EHT) WLAN.

Many sub-7 GHz WLAN Sensing use cases, especially those categorized as Room Sensing in IEEE contribution 21/1047r1 (Legacy Support in 11bf, Rojan Chitrakar) may involve low complexity internet of things (IOT) devices (e.g., TV sets, smart home appliances such as Washing machines, Refrigerators, Air conditioners etc., Wi-Fi enabled vending machines etc.) to perform sensing measurement. Many of these devices have comparatively long shelf lives and hence legacy WLAN devices (e.g., 802.11ac in the 5 GHz band, 802.11n in the 2.4 GHz, 5 GHz bands) are expected to be part of the WLAN Sensing eco system for a good number of years. Support of 802.11bf on low complexity 802.11 devices (with/without legacy PHYs) will encourage earlier and wider adoption of standardized WLAN Sensing.

In a recent 802.11bf meeting, it is proposed that 11bf shall ensure at least one mode of operation in which 11bf can be supported on devices with legacy physical layers (PHYs) such as 802.11n or 802.11ac, and that they can participate in WLAN Sensing. While 802.11n and 802.11ac have been cited as example of legacy PHYs here, it is not meant to preclude other 802.11 PHYs such as 802.11a, 802.11b, 802.11g, 802.11ax, which could also be considered as legacy PHYs if the host device did not support 802.11bf natively.

However, there has been no discussion so far concerning low complexity WLAN sensing related to support of low complexity (IOT type) devices (with/without legacy PHYs).

There is thus a need for communication apparatuses and methods that can solve the above mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for low complexity WLAN sensing.

According to an aspect of the present disclosure, there is provided a first communication apparatus comprising: a receiver, which in operation, receives a measurement request frame from a second communication apparatus, the measurement request frame carrying a delayed response field indicating whether a delayed response is allowed; and a transmitter, which in operation, transmits a measurement Physical Protocol Data Unit (PPDU) to be used for channel measurements in response to the measurement request frame.

According to another aspect of the present disclosure, there is provided a second communication apparatus, comprising: a receiver, which in operation, receives information relating to a first communication apparatus; circuitry, which in operation, generates a measurement request frame based on the information, the measurement request frame carrying a delayed response field indicating whether a delayed response is allowed; and a transmitter, which in operation, transmits a measurement request frame to the first communication apparatus.

According to another aspect of the present disclosure, there is provided a communication method comprising: receiving a measurement request frame from a communication apparatus, the measurement request frame carrying a delayed response field indicating whether a delayed response is allowed; and transmitting a measurement Physical Protocol Data Unit (PPDU) to be used for channel measurements in response to the measurement request frame.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 illustrates an overview of a WLAN Sensing protocol according to an example.

FIG. 2 depicts an illustration of a sensing process according to an example.

FIG. 3 depicts an illustration of a network according to an example.

FIG. 4 depicts an implementation of a sensing process in accordance with various embodiments.

FIG. 5 depicts another implementation of a sensing process in accordance with various embodiments.

FIG. 6 depicts an illustration of a Type 1 station (STA) with legacy physical layer (PHY) in accordance with a first embodiment.

FIG. 7 depicts an illustration of a WLAN Sensing Capability element in accordance with a first embodiment.

FIG. 8 depicts an illustration of setting up sensing windows during the setup phase utilizing Scheduled Automatic Power Save Delivery (S-APSD) in accordance with a first embodiment.

FIG. 9 depicts an illustration of a sensing setup request frame and a sensing setup response frame in accordance with a first embodiment.

FIG. 10 depicts an illustration of setting up sensing windows during the setup phase utilizing individual target wakeup time (TWT) service periods (SPs) in accordance with a first embodiment.

FIG. 11 depicts an illustration of an individual TWT Setup frame in accordance with a first embodiment.

FIG. 12 depicts an illustration of setting up sensing windows during the setup phase utilizing broadcast TWT SPs in accordance with a first embodiment.

FIG. 13 depicts an illustration of a broadcast TWT element in accordance with a first embodiment.

FIG. 14 depicts an illustration of a Sensing Setup Request frame and a Sensing Setup Response frame for negotiating TWT SP in accordance with a first embodiment.

FIG. 15 depicts an illustration of a measurement phase in accordance with a first embodiment.

FIG. 16 depicts an illustration of PHY receiving (RX) modes in accordance with a first embodiment.

FIG. 17 depicts an illustration of a Measurement Request frame in accordance with a first embodiment.

FIG. 18 depicts an illustration of a solicited measurement using a Measurement Request frame with padding in accordance with a first embodiment.

FIG. 19 depicts an illustration of a solicited measurement using a Measurement Request frame within an aggregated MAC protocol data unit (A-MPDU) in accordance with a first embodiment.

FIG. 20 depicts an illustration of a new Ranging Trigger subtype (802.11az) defined as a Measurement Request frame in accordance with a first embodiment.

FIG. 21 depicts an illustration of a PHY receive procedure in sensing measurement mode for a very high throughput (VHT) null data packet (NDP) in accordance with a first embodiment.

FIG. 22 depicts an illustration of a solicited measurement in which delayed response is allowed in accordance with a first embodiment.

FIG. 23 depicts an illustration of a VHT NDP Announcement frame in accordance with a first embodiment.

FIG. 24 depicts an illustration of an unsolicited measurement process with a Type 1 sensing initiator in accordance with a first embodiment.

FIG. 25 depicts an illustration of an unsolicited measurement process with a Type 1 responder in accordance with a first embodiment.

FIG. 26 depicts an illustration of a sensing phase summary in accordance with a first embodiment.

FIG. 27 depicts an illustration of an example WLAN sensing deployment with two Type 1 Sensing STAs in accordance with a second embodiment.

FIG. 28 depicts an illustration of an example sensing measurement using Data frame as Measurement PPDUs in accordance with a second embodiment.

FIG. 29 depicts an illustration of a Sensing measurement phase using Sounding PPDUs as Measurement PPDUs in accordance with a second embodiment.

FIG. 30 depicts an illustration of an example transmit procedure for a VHT sounding sequence in accordance with a second embodiment.

FIG. 31 depicts an illustration of an example WLAN sensing deployment with two Type 1 Sensing STAs in accordance with a third embodiment.

FIG. 32 depicts an illustration of a sensing measurement process in accordance with a third embodiment.

FIG. 33 depicts an illustration of an example WLAN sensing deployment with a Type 1 STA and a Type 2 STA in accordance with a fourth embodiment.

FIG. 34 depicts an illustration of an Ethertype 89-0d frame in accordance with a fourth embodiment.

FIG. 35 depicts an illustration of an example WLAN sensing procedure between a Type 1 STA (STA1) and a Type 2 STA (AP) in accordance with a fourth embodiment.

FIG. 36 depicts an illustration of an example WLAN sensing procedure between a Type 1 STA (STA1) and a Type 2 STA (Sensing Initiator) in accordance with a fourth embodiment.

FIG. 37 shows a flow diagram illustrating a method for low complexity WLAN sensing according to various embodiments.

FIG. 38 shows a schematic, partially sectioned view of a STA that can be implemented for low complexity WLAN sensing in accordance with various embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

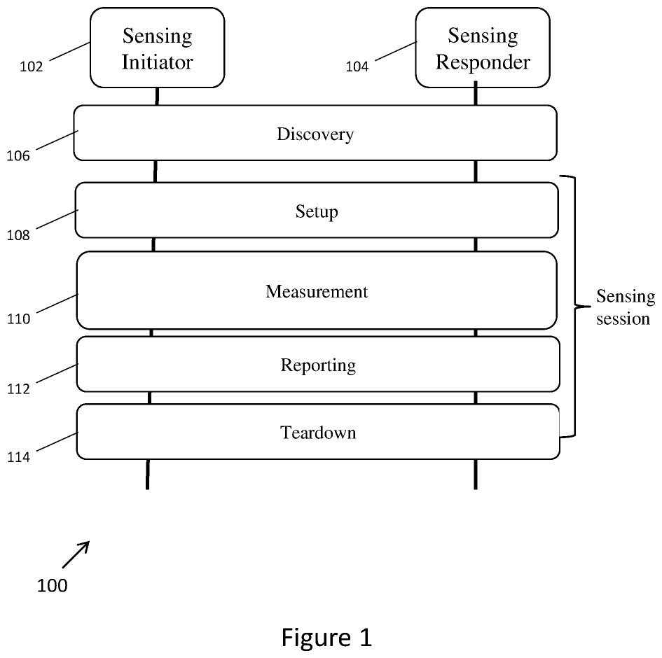

Overview of WLAN Sensing protocol is provided in IEEE contributions 21/504r1 (Specification Framework for TGbf, Claudio da Silva) and 20/1851r4 (Overview of Wi-Fi Sensing Protocol, Cheng Chen et. al.). Referring to FIG. 1, WLAN sensing protocol 100 between a sensing initiator 102 and a sensing responder 104 may be divided into a discovery phase 106, a setup phase 108, a measurement phase 110, a reporting phase 112 and a teardown phase 114. In the discovery phase 106, information relating to capabilities of the sensing initiator 102 and the sensing responder 104 are exchanged, for example, during association of the sensing initiator 102 and the sensing responder 104. In the setup phase 108, a sensing session between the sensing initiator 102 and the sensing responder 104 is established, with identification of sensing transmitter(s) and sensing receiver(s) of the sensing initiator 102 and the sensing responder 104, as well as determination of associated parameters of sensing transmission. In the measurement phase 110, the sensing transmitter(s) perform transmissions to sensing receivers for measurement purposes. In the reporting phase 112, depending on the scenario, sensing receiver(s) may need to feedback measurement results to the sensing initiator 102. In the teardown phase 114, the sensing session is ended in an explicit or implicit manner.

The Setup phase 108 is used to setup a sensing session between two or more Sensing STAs. A sensing procedure allows a STA to perform WLAN sensing and obtain measurement results. A sensing session is an instance of a sensing procedure with associated operational parameters of that instance. A sensing initiator is a STA that initiates a WLAN sensing session. A sensing responder is a STA that participates in a WLAN sensing session initiated by a sensing initiator. A sensing transmitter is a STA that transmits PPDUs used for sensing measurements in a sensing session. A sensing receiver is a STA that receives PPDUs sent by a sensing transmitter and performs sensing measurements in a sensing session. A STA can assume multiple roles in one sensing session. In a sensing session, a sensing initiator may be a sensing transmitter, a sensing receiver, both or neither.

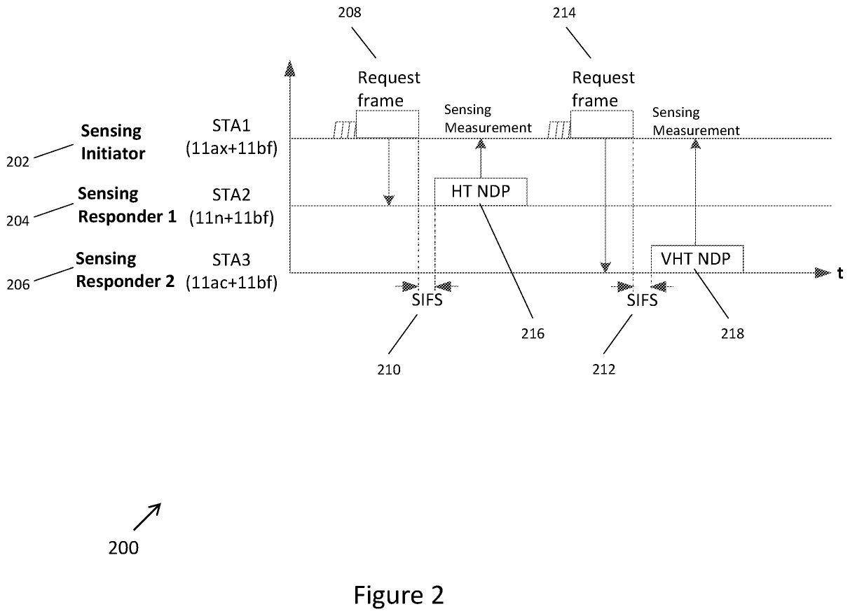

Low complexity internet of things (IOT) devices are typically characterized by use of low capability hardware (CPU, memory etc.) leading to constraints on processing power, response time, storage capacity, and other similar specifications. Many of such low complexity IOT devices may be battery operated and thus have constraints in power usage. The low complexity IOT devices including devices with legacy PHYs may not be able to comply with some of the measurement sequences currently being discussed in 11bf. These may be applicable for IOT devices as well (even devices with the latest PHYs). For example, a low complexity device (e.g. legacy devices) may not be able to respond with NDPs within a short interframe space (SIFS) of 16 μS after receiving a Request frame such as a Sensing Request frame, for example as shown in FIG. 2 wherein sensing responder 204 may not be able to respond with a HT NDP 216 within a SIFS 210 after receiving a request frame 208 from sensing initiator 202, and sensing responder 206 may not be able to respond with a VHT NDP 218 within a SIFS 212 after receiving a request frame 214 from sensing initiator 202. However, not all devices with legacy PHY may be low complexity devices, while some devices with latest PHYs may also be considered as low complexity devices.

The WLAN Sensing protocol (in particular the Measurement and Reporting phases) currently being discussed in 11bf is not suitable nor optimized for low complexity devices as well as for devices running legacy PHYs (11n, 11ac). Thus, it is desirable to optimize the WLAN Sensing protocol (in particular the Measurement and Reporting phases) for low complexity devices as well as for devices running legacy PHYs (11n, 11ac) to address processing delay (e.g., to factor in slow response to measurement request frame) and power profile (e.g., to allow low power operation for battery operated devices). While 802.11n and 802.11ac have been cited as example of legacy PHYs here, it is not meant to preclude other 802.11 PHYs such as 802.11a, 802.11b, 802.11g, 802.11ax, which could also be considered as legacy PHYs if the host device did not support 802.11bf natively.

According to their supported capabilities or supported PHY versions, 11bf STAs may be categorized into two types:
Type 1 (Basic): E.g., STAs with legacy PHYs, IOT STAs
Type 2 (Advanced): E.g., Non-IOT type STAs, STAs with the latest PHY

Type 1 (Basic) STAs are 11bf STAs that have constraints (e.g., due to hardware capabilities) in terms of one or more of the following:
Computation capacity/Processing power;
Power profile;
Supported PHYs;
   and only support basic 11bf features such as sensing based on legacy sounding and feedback types, and/or sensing between a single pair of STAs etc. For simplicity, STAs that only support legacy PHYs such as 11n, 11ac may be classified as Type 1 STAs regardless of their hardware capabilities. While 802.11n and 802.11ac have been cited as example of legacy PHYs here, it is not meant to preclude other 802.11 PHYs such as 802.11a, 802.11b, 802.11g, 802.11ax, which could also be considered as legacy PHYs if the host device did not support 802.11bf natively.

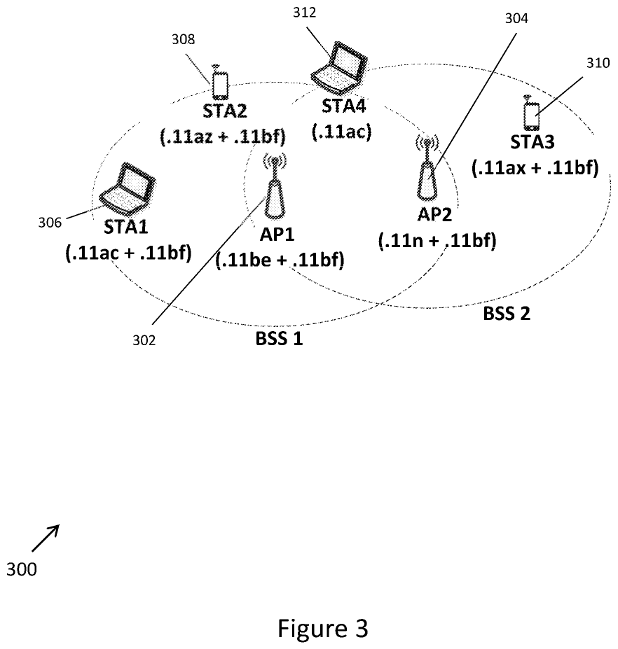

On the other hand, Type 2 (Advanced STAs) are 11bf STAs that have no such constraints and may support advanced 11bf features (e.g., secure long training fields (LTFs), Trigger based sensing measurement etc.). Type 2 STAs may also be known as Non-Basic STAs. For example, referring to network 300 of FIG. 3, AP1 302 (supports 802.11be and 802.11bf), STA2 308 (supports 802.11az and 802.11bf) and STA3 310 (supports 802.11ax and 802.11bf) are Type 2 (Advanced) 11bf STAs, while STA1 306 (supports 802.11ac and 802.11bf) and AP2 304 (supports 802.11n and 802.11bf) are Type 1 (Basic) 11bf STAs. Further, STA4 312 (supports 11ac) is not a 11bf STA but may still be able to participate in WLAN Sensing. In this disclosure, we explore options to make the Type 1 STAs and Type 2 STAs participate together in a sensing session.

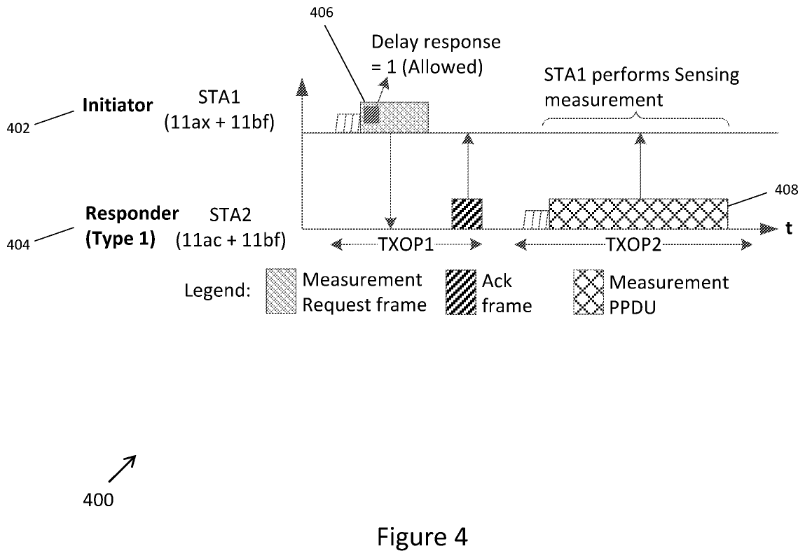

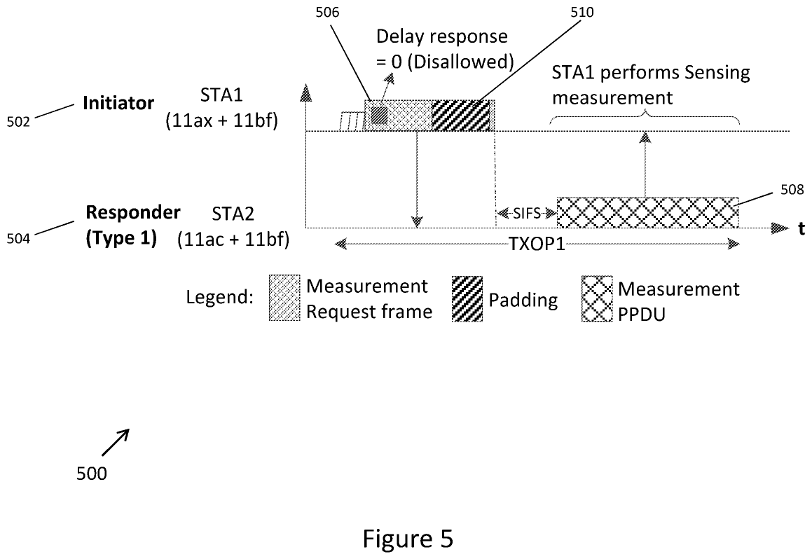

Referring to FIG. 4, when the Sensing Responder 404 is a Type 1 STA, the Sensing Initiator 402 uses the delayed response field in Measurement Request frame 406 to indicate whether a delayed response is allowed, in which case the Sensing Responder 404 may transmit a Measurement PPDU 408 in a delayed fashion (i.e., not within SIFS), for example in a different transmit opportunity (TXOP). Alternatively, referring to FIG. 5, the Sensing Initiator 502 may use the delayed response field in Measurement Request frame 506 to indicate that delayed response is not allowed, however, the Sensing Initiator 502 may include one or more Padding fields 510 in the Measurement Request frame 506 to provide the Sensing Responder 504 more time to respond with Measurement PPDU 508 within SIFS from the end of the Measurement Request frame 506 in a same TXOP. The Sensing Responder 504, upon receiving the Measurement request frame 506 and detecting the start of the Padding field 510, may start preparing for transmission of the Measurement PPDU 508. The Sensing Responder 504 may detect a start of the Padding field 510 and, in response to the detection, transmit the measurement PPDU 508 within a fixed duration after the Measurement Request frame 506 is received. Measurement PPDUs 408 and 508 may be used for channel measurements by the Sensing Initiator 402, 502. A STA may advertise itself as being one of a Type 1 or Type 2 device, the Type 1 device being of lesser capability than the Type 2 device; wherein the delayed response field in a Measurement Request frame is set to indicate that delayed response is allowed if the Sensing Responding STA is a Type 1 device, and set to indicate that delayed response is not allowed if the Sensing Responding STA is a Type 2 device.

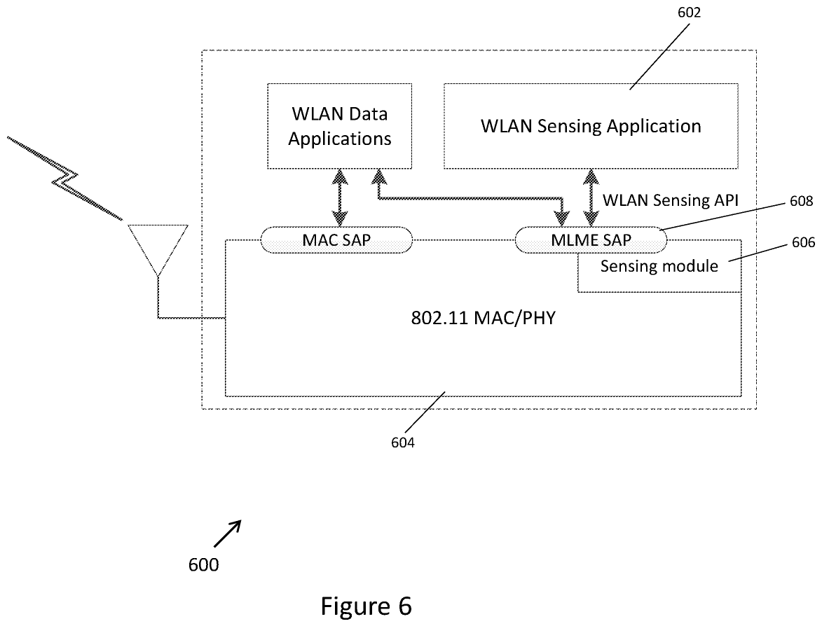

In a first embodiment E1, it is considered that Type 1 STAs with legacy PHYs are upgraded with 11bf modifications either during factory installations or even post-deployment through firmware updates and/or patches and support most 11bf related changes to the medium access control (MAC) and MAC-PHY interfaces. Referring to illustration 600 of FIG. 6, WLAN Sensing application 602 that sits above MAC 604 interacts with Sensing module 606 in the MAC 604 via MAC sublayer management entity (MLME) service access point (SAP) (e.g. Management plane) 608. An 11bf STA advertises its Sensing STA Type (Type 1 or Type 2) e.g., by using a WLAN Sensing Capability element in relevant frames such as:

Beacon, Probe Response, Association Response, Sensing Request/Response frame etc. transmitted by a Sensing STA that is an AP, or
Probe Request, Association Request, Sensing Request/Response frame etc. transmitted by a Sensing STA that is a non-AP STA.

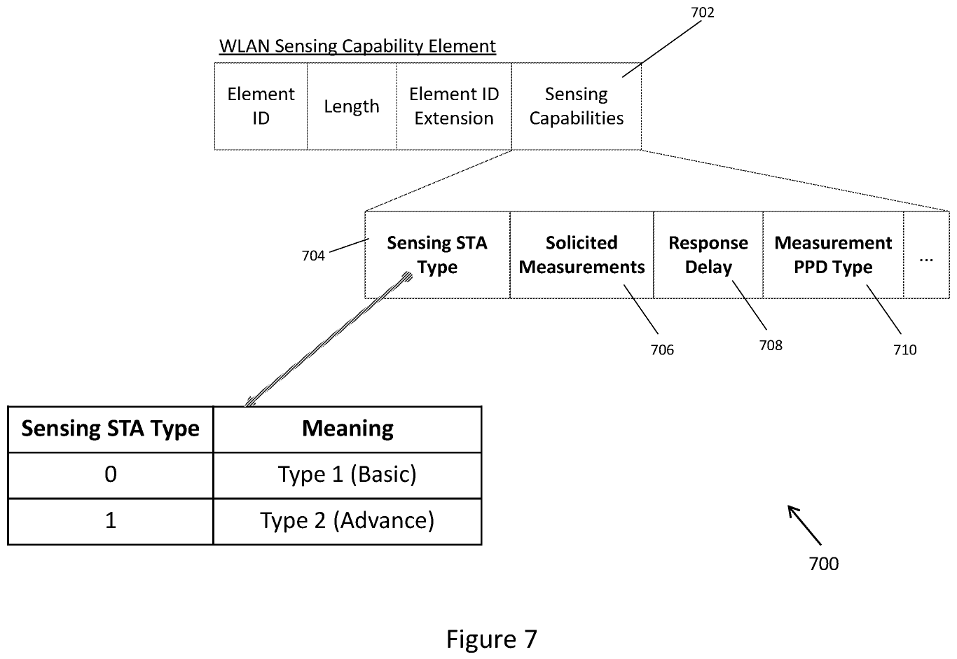

FIG. 7 depicts a WLAN Sensing Capability element 700 which may comprise a Sensing Capabilities field 702. The Sensing Capabilities field 702 may comprise a Sensing STA type field 704 that may be used to indicate the STA Type, e.g., it may have a value of ‘0’ to indicate that the sensing STA type is Type 1 (Basic), or a value of ‘1’ to indicate that the sensing STA type is Type 2 (Advanced). The Sensing Capabilities field 702 may also comprise a Solicited Measurements field 706 that may indicate whether the concerned STA supports solicited measurements, for example responding with a Measurement PPDU (e.g., NDP or PPDU carrying Data frames etc.) upon receiving a Measurement Request frame. If set as Yes to indicate that solicited measurement is supported by the STA, it may further indicate the type of Measurement PPDU that will be used for responding to the Measurement Request frame, for example indicating whether it is a NDP or an 802.11 PPDU carrying Data frame etc. Thus, a STA may be able to advertise whether it is capable of transmitting a measurement PPDU upon receiving a Measurement request frame (e.g. whether solicited measurement is supported by the STA) and, if it is advertised to be capable of doing so, further advertise, in the Measurement PPDU Type field 710, a type of measurement PPDU that it is capable of transmitting, the type of measurement PPDU being a NDP or an 802.11 PPDU carrying a Data frame etc. A Type 1 STA that supports solicited measurement may further advertise, for example via a Response delay field 708, a duration (e.g. >SIFS) it requires to respond with a Measurement PPDU (e.g., NDP, Data frames) upon receiving a Measurement Request frame. For example, the Response delay field 708 may be set as 0 if it is able to respond within a SIFS (e.g. transmit a measurement PPDU within a SIFS of receiving a measurement request frame), or any higher non-zero value to indicate otherwise, e.g., 1 to indicate a response delay of 32 μS, 2 to indicate a response delay of 48 μS etc. Alternatively, the Solicited Measurement itself may indicate whether the STA supports immediate or delayed response:
0: solicited measurement is not supported
1: supports delayed transmission of measurement PPDU
2: supports immediate transmission of measurement PPDU.

A separate field e.g., “NDP Measurement PPDU supported” may be used to indicate whether it supports solicited NDP transmissions.

An 11bf STA's supported PHYs and respective PHY capabilities may be advertised/discovered through inclusion of HT/VHT/HE/EHT capabilities elements in relevant frames and may be independent of its Sensing STA Type capability. Alternatively, the Sensing STA Type may not be explicitly signalled but derived based on the STA's other capabilities. For example, all STAs that only support legacy PHYs such as 11n, 11ac are considered Type 1 (Basic) Sensing STAs while STAs with newer PHYs such as HE/EHT are considered Type 2 (Advance) Sensing STAs. Or if the value of the Response Delay field is non-zero, the STA may be considered a Type 1 STA and those with the value of the Response Delay field equal to zero is considered as Type 2 STA. Type 1 STAs that are legacy devices upgraded with 11bf modifications would mean that the devices' software are upgraded (e.g., through firmware update/patch) and support relevant 11bf MAC features and MAC-PHY interfaces.

WLAN Sensing related information discovered during active/passive scans may be forwarded to the upper layer via a MLME-SCAN.confirm primitive as shown below:

```
MLME-SCAN.confirm(
  BSSDescriptionSet,
    :
    :
    )
```

Two parameters related to WLAN Sensing may be included in the above-mentioned BSSDescriptionSet, as shown in Table 1 below:

TABLE 1

| Name | Description |
|---|---|
| WLAN Sensing | The parameters from the WLAN |
| Capabilities | Sensing Capabilities element. |
| WLAN Sensing | The parameters from the WLAN |
| Operation | Sensing Operation element. |

The following parameters may be negotiated during the Setup phase:
1) Sensing roles:
   By default, a STA initiating the Setup will assume the role of Sensing Initiator, while a peer STA will be the Sensing Responder. The roles of Sensing Transmitter/Receiver may be subject to negotiation.
2) Transmission Parameters for the PPDU to be used for Sensing measurement:
   PPDU format, channel bandwidth, number of spatial streams, transmit power. The parameters are subject to the supported PHYs. During the setup phase, one or more time windows in which to perform a sensing measurement may also be negotiated. In addition, the sensing sequence for sensing measurement may also be negotiated as:
A) Solicited (or triggered based): Sensing Initiator will transmit an explicit frame (e.g. Measurement Request frame) to solicit (or trigger) the measurement PPDU from the Sensing Responder.
B) Unsolicited (or non-triggered based): Sensing Initiator will transmit the measurement PPDU and the Responder may be asked to provide feedback with the sensing measurement result.
3) Measurement feedback type:
   Type 1 Sensing STAs may only be able to support the default feedback types, e.g., channel state information (CSI), compressed/non-compressed beamforming for 11n and only compressed beamforming for 11ac. Type 2 Sensing STAs may support additional feedback types e.g., compressed/non-compressed 11bf CSI Matrix.

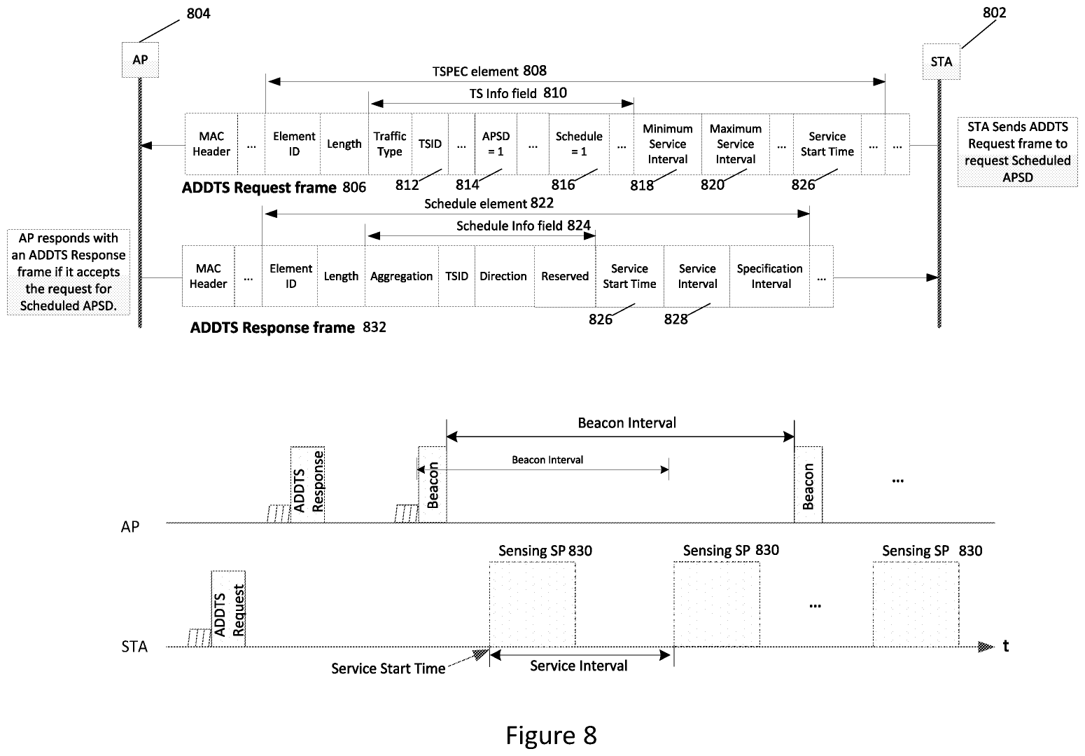

When either one of the Sensing STA pair is a Type 1 Sensing STA with legacy PHY and either one is also an AP, scheduled automatic power save delivery (S-APSD) may be used to schedule Sensing Service Periods (SP) i.e. the one or more time windows being negotiated may be S-APSD SPs. FIG. 8 depicts an illustration of a Sensing Setup phase 800 in accordance with the first embodiment. As part of the Sensing Setup phase, to use a scheduled SP (Service Period) for sensing measurements, a non-AP STA 802 sends an add traffic stream (ADDTS) Request frame 806 to AP 804 with APSD subfield 814 and Schedule subfield 816 of a traffic stream information (TS Info) field 810 in traffic specifications (TSPEC) element 808 both set to 1. The AP 804 responds with an ADDTS Response frame 832 if it accepts the request for scheduled APSD. The ADDTS Response frame 832 may comprise a Schedule element 822 comprising a Schedule Info field 824, Service Start time field 826 and Service Interval field 828.

Such scheduled SPs may be called Sensing SPs (SSPs) e.g. SSPs 830. A specific value of the traffic stream identifier (TSID) field 812 is reserved (E.g., 15) to indicate a Sensing SP. Alternatively, a reserved bit from among B17-B23 of the TS Info field 810, or a reserved bit from among B7-B15 of Schedule Info field 824 may be used to indicate Sensing SP.

A Minimum Service Interval field 818 in the TSPEC element 808 may contain an unsigned integer that specifies a minimum interval, in microseconds, between the start of two successive SPs. A Maximum Service Interval field 820 may contain an unsigned integer that, is used to indicate a latency limit, which limits the amount of aggregation (A-MSDU or A-MPDU) used, so that excessive latency does not occur. The Service Start Time field 826 contains an unsigned integer that specifies the time, expressed in microseconds, when the first scheduled SP starts. The service start time in the TS Info field 810 indicates to the AP 804 the time when a STA first expects to be ready to perform Sensing measurements and a power saving STA needs to be awake to receive frames used for sensing measurements. This may advantageously help the AP 804 to schedule service so that the frames used for sensing measurements encounter small delays in the MAC and help the power saving STAs to reduce power consumption. The field represents the four lower order octets of the TSF timer at the start of the SP.

If the APSD mechanism is supported by the AP 804 and the AP 804 accepts the corresponding ADDTS Request frame 806 from the STA 802, the AP responds to the ADDTS Request frame 806 with a response (e.g. ADDTS Response frame 832) containing the Schedule element 822 indicating that the requested service can be accommodated by the AP 804.

Service Start Time field 826 indicates the anticipated time, expressed in microseconds, when service starts and represents the lower order 4 octets of the TSF timer value at the start of the first SP. The AP 804 uses this field to confirm or modify the service start time indicated in the TSPEC request. The Service Interval field 828 indicates the time, expressed in microseconds, between two successive SPs and represents the measured time from the start of one SP to the start of the next SP. A scheduled SP begins at the scheduled wakeup time that corresponds to the scheduled interval (SI) and the service start time indicated in the Schedule element 822 sent in response to a TSPEC Request. Only frames/PPDUs related to WLAN Sensing may be allowed to be exchanged during the Sensing SPs 830.

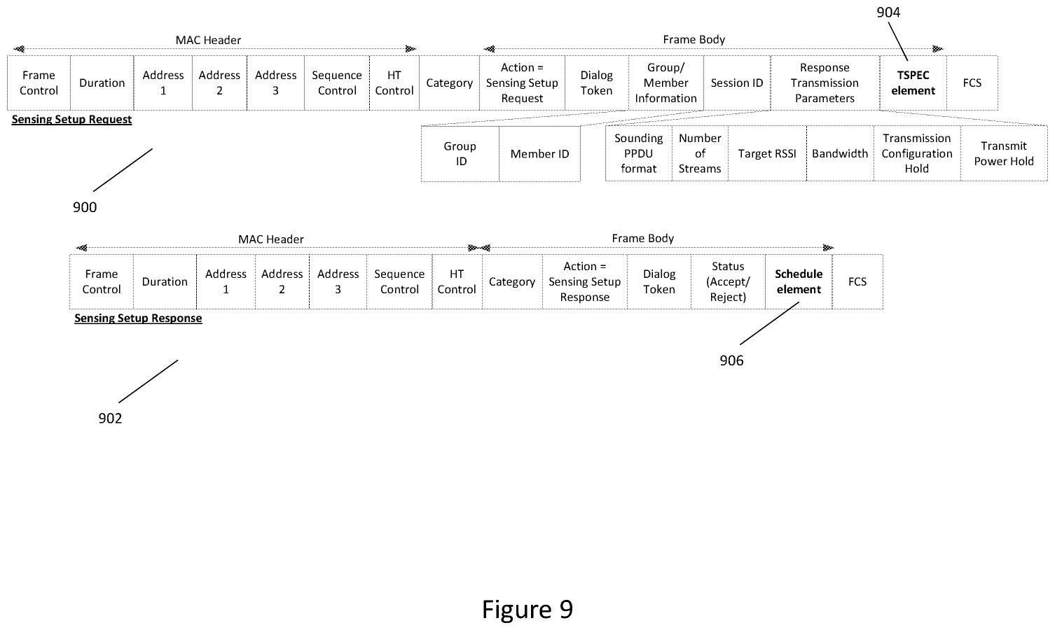

Alternatively, instead of using ADDTS Request/Response frames, Schedule APSD for Sensing SPs may be negotiated by including the TSPEC element in a Sensing Setup Request frame and including the Schedule element in a Sensing Setup Response frame, such as shown in Sensing Setup Request frame 900 and Sensing Setup Response frame 902 in FIG. 9. For example, Sensing Setup Request frame 900 may comprise a TSPEC element 904 and Sensing Setup Response frame 902 may comprise a Schedule element 906.

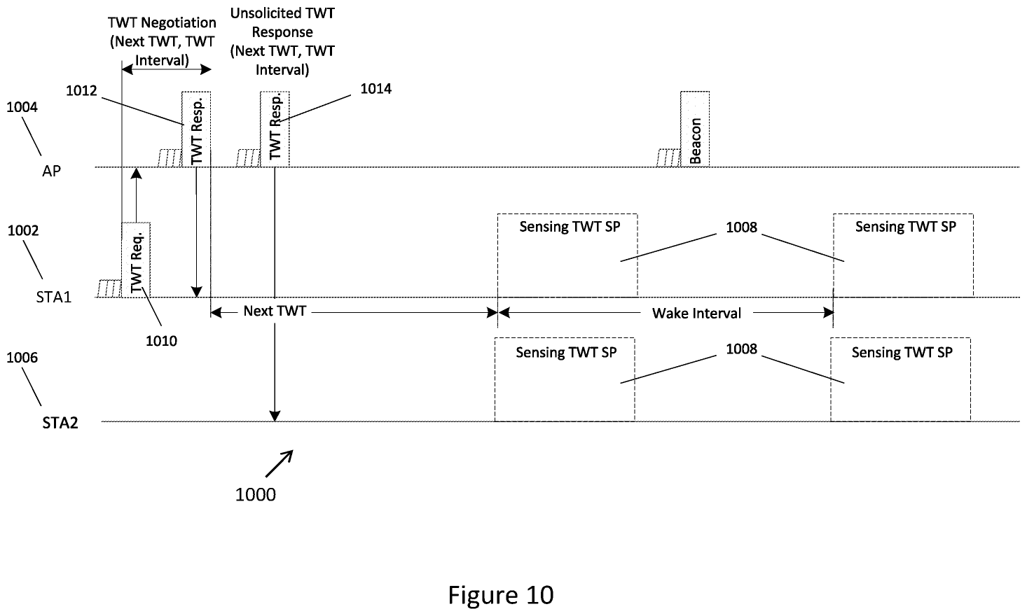

Between two or more Sensing STAs that support target wait time (TWT) (e.g., Type 2 Sensing STAs or Type 1 STAs with 11ax PHY), TWT SPs may be used to schedule Sensing Service Periods (SP). In a first option, individual TWT SPs may be used, for example as shown in illustration 1000 of FIG. 10. During the Setup phase, Sensing STAs (e.g., AP 1004 and STA1 1002) may negotiate Individual TWT SPs 1008 to be used for WLAN Sensing by exchanging TWT Setup frames e.g. TWT SPs are being negotiated for use as one or more time windows in which sensing measurements are performed. For example, STA 1002 may send a TWT Request frame 1010 to AP 1004, which may respond with a TWT Response frame 1012 if the AP 1004 accepts the TWT request. The TWT Responder (AP 1004 in this example) may also schedule another Sensing STA (e.g., STA2 1006) to join the TWT SP by sending an unsolicited TWT Response frame 1014 to the STA2 1006. Only frames/PPDUs related to WLAN Sensing may be allowed to be exchanged during Sensing SPs 1008. In order to protect the Sensing TWT SP from other STAs, the Sensing STAs may also negotiate the TWT SP to be “Protected” e.g., the Sensing TWT SP starts with Request To Send (RTS)/Clear To Send (CTS) exchange.

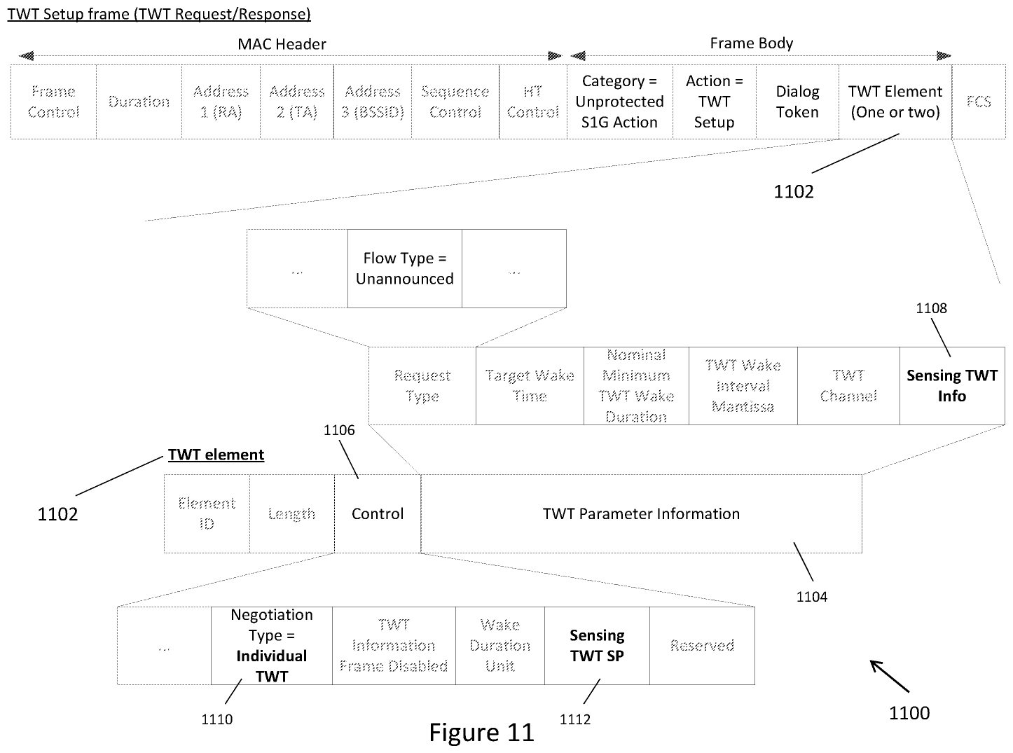

FIG. 11 depicts an illustration of an individual TWT Setup frame 1100 in accordance with the first embodiment. TWT Setup frame 1100 may be used as a TWT Request frame (e.g. TWT Request frame 1010 in FIG. 10) and/or a TWT Response frame (e.g. TWT Response frames 1012 and 1014 in FIG. 10), and may comprise one or two TWT element 1102. The TWT element 1102 may comprise a Sensing TWT Info field 1108 in a TWT Parameter Information field 1104. The Sensing TWT Info field 1108 may be used to carry parameters relevant to Sensing SP, e.g. Solicited/Unsolicited measurements, feedback type, and other similar parameters. The TWT element 1102 may further comprise, in a Control field 1106, a Negotiation Type field 1110 and a Sensing TWT SP field 1112. The Negotiation Type field 1110 may be configured to indicate the negotiation type of the TWT Setup frame 1100 as ‘Individual TWT’, and the Sensing TWT SP field 1112 may indicate that the concerned TWT SP is for Sensing and that the Sensing TWT Info field 1108 is included in the TWT Parameter Information field 1104. The Sensing TWT Info field 1108 may be used to carry parameters relevant to Sensing SP, e.g., Solicited/Unsolicited measurements, feedback type etc.

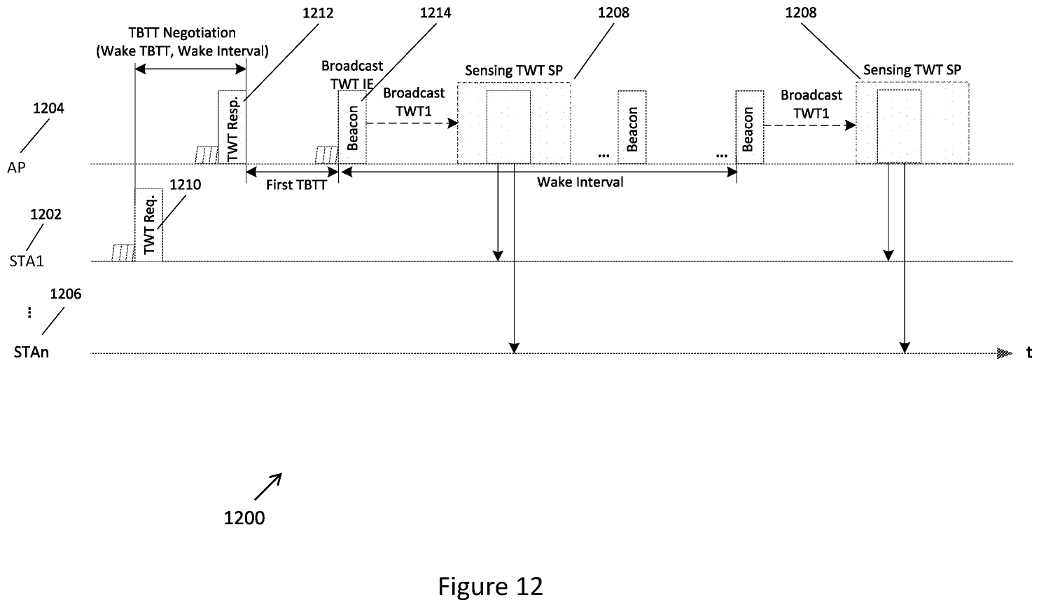

In a second option, broadcast TWT SPs may be used to schedule Sensing SPs. FIG. 12 depicts an illustration of a setup phase 1200 utilizing broadcast TWT SPs in accordance with the first embodiment. When the Sensing transmitter is an AP (e.g. AP 1204), the AP may announce TWT SPs dedicated for sensing by including one or more broadcast TWT elements in the Beacon and Probe Response frames transmitted by the AP 1204. During the Sensing Setup phase, Sensing STAs (e.g., STA1 1202 and STAn 1206) may negotiate to join the broadcast Sensing TWT SPs 1208 and 1216 to be used for WLAN Sensing by exchanging TWT Setup frames with the AP 1204. For example, in a target beacon transmission time (TBTT) negotiation phase in which a Wake TBTT and a Wake Interval is negotiated, STA 1202 may send a TWT Request frame 1210 to AP 1204, which may respond with a TWT Response frame 1212 if the AP 1204 accepts the TWT request. At a first TBTT after end of transmission of the TWT Response frame 1212, a Broadcast TWT element 1214 may be broadcasted in the Beacon frames transmitted by the AP 1204, and a Sensing TWT SP 1208 may be scheduled within a Wake Interval after the first TBTT. The Sensing TWT SPs 1208 and 1216 may also be protected from third party STA transmission by scheduling quiet intervals that overlap with the Sensing TWT SPs 1208. The overlapping quiet intervals may be scheduled by including one or more Quiet elements in the Beacon and Probe Response frames transmitted by the AP 1204. Broadcast TWT based Sensing TWT SPs may be suitable for solicited or unsolicited sensing measurements that involve multiple Sensing Responders.

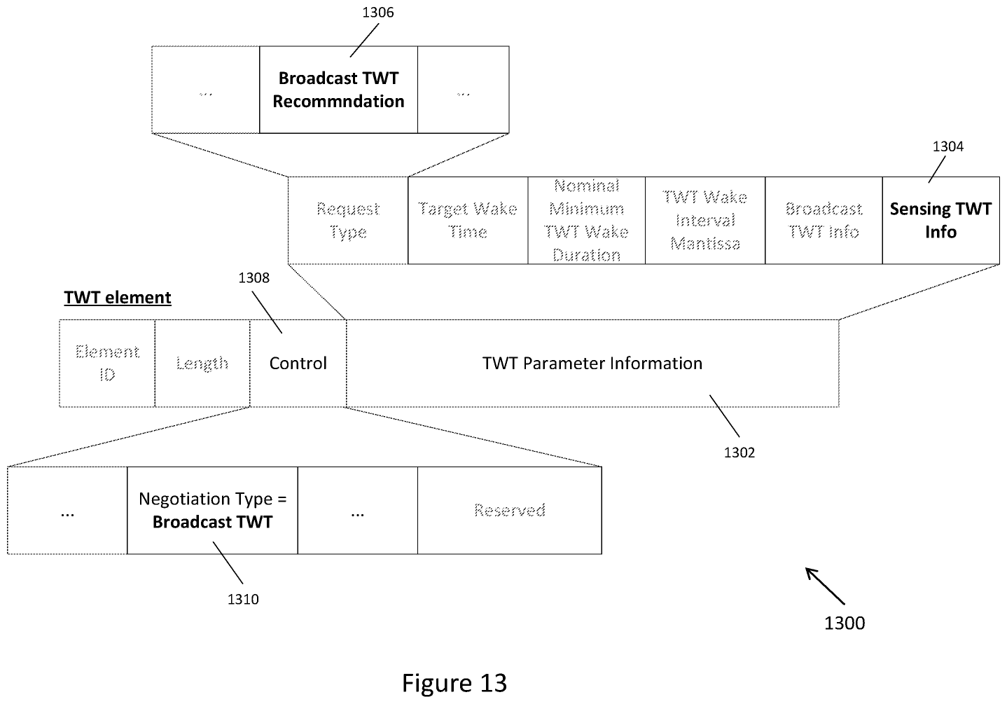

FIG. 13 depicts an illustration of a TWT element 1300 that may be used for setting up broadcast TWT SPs, for example utilised as Broadcast TWT element 1214 in FIG. 12. The TWT element 1300 may comprise, in a TWT Parameter information field 1302, a Sensing TWT Info field 1304 that may be used to carry parameters relevant to Sensing SP, e.g. Solicited/Unsolicited measurements, feedback type, and other similar parameters. The TWT Parameter Information field 1302 may further comprise, in a Request Type field, a Broadcast TWT Recommendation field 1306 in which a reserved value e.g., 5 may be used to indicate that the broadcast TWT SP is for Sensing and that the Sensing TWT Info field 1304 is included in the TWT Parameter Information field 1302. The TWT element 1300 may further comprise, in a Control field 1308, a Negotiation Type field 1310 which may be used to indicate that the TWT element 1300 is for setting up Broadcast TWT SPs. The Sensing TWT Info field 1304 may be used to carry parameters relevant to Sensing SP, e.g., Solicited/Unsolicited measurements, feedback type etc.

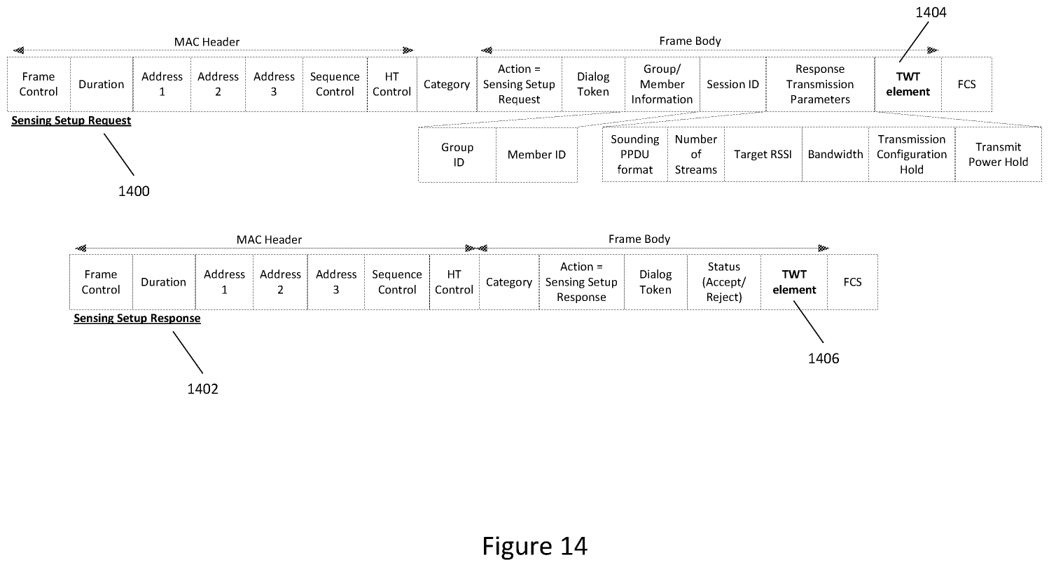

Alternatively, instead of using TWT Request/Response frames, TWT SP for Sensing SPs may be negotiated by including the TWT element in the Sensing Setup Request frame and Sensing Setup Response frame, such as shown in Sensing Setup Request frame 1400 having a TWT element field 1404 and Sensing Setup Response frame 1402 having a TWT element field 1406 of FIG. 14. Sensing Setup Request frame 1400 and Sensing Setup Response frame 1402 may be utilised as WLAN Sensing Session Request/Response frames. The TWT element field 1404 and 1406 may be the same as the TWT element 1102 in FIG. 11 or the TWT element 1300 in FIG. 13.

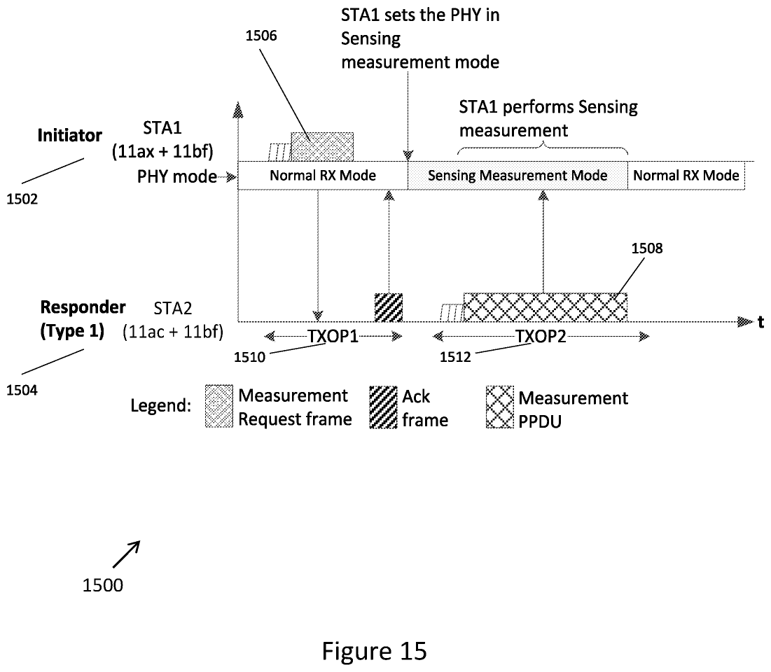

When solicited measurement is used for sensing measurements such as shown in FIG. 15, a Type 2 Sensing Initiator STA1 1502 (11ax+11bf) may transmit a Measurement Request frame 1506 to a Type 1 Sensing Responder STA2 1504 (11ac+11bf) to trigger a transmission of a Measurement PPDU 1508 (e.g., NDP). When the Sensing Responder 1504 is a Type 1 STA, it may not be able to respond with a Measurement PPDU 1508 within a SIFS after completion of reception of the Measurement Request frame 1506. In such cases, the Measurement Request frame 1506 may indicate that delayed response is allowed, e.g., in a “delayed response” field, and the Sensing Responder 1504 may transmit the Measurement PPDU 1508 in a delayed manner, either in the same TXOP or in a different TXOP obtained by the Sensing Responder (e.g. in TXOP2 1512 instead of TXOP1 1510).

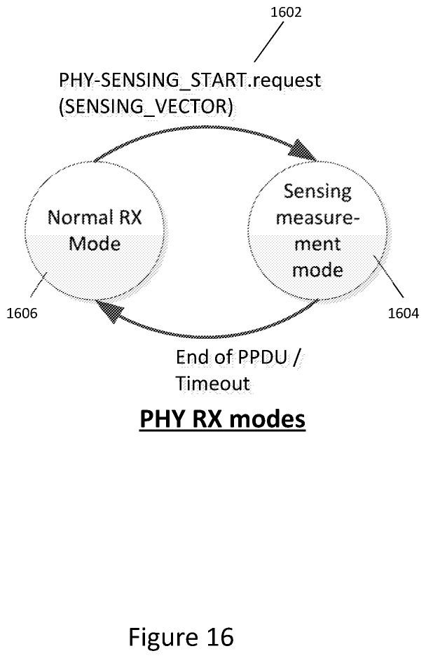

Further, referring to illustration 1600 of FIG. 16, a PHY primitive PHY-SENSING_START.request 1602 may be defined to put a Sensing Receiver's PHY in Sensing measurement mode 1604 in which the PHY will extract the Sensing measurements (e.g., CSI) from non-legacy LTFs (e.g, HT/VHT/HE/EHT-LTFs) and pass them to the MAC. The PHY may automatically transition back to the Normal RX mode 1606 at the end of the PPDU, or another PHY primitive (e.g., PHY-SENSING_STOP.request) may be defined for the purpose.

Compared to the normal RX mode 1606, the extraction of the Sensing measurements may be computationally more expensive and may also consume higher power. In the above example 1500 in FIG. 15, the Initiator 1502 switches its PHY to the Sensing measurement mode 1604 immediately after receiving an acknowledgment to the Measurement Request frame in order to prepare the PHY for extraction of Sensing measurement. However, since the Measurement PPDU is transmitted in a subsequent different TXOP, factors like channel access delay etc. may cause some uncertainty in the amount of time that the PHY is in this mode. If the Initiator does not detect a Measurement PPDU within a certain duration, it may set its PHY back to the Normal RX mode 1606.

The receiving capability of a device's PHY when in the Sensing Measurement mode 1604 may be hardware dependent. The PHY of some Type 1 STAs may only be able to detect PPDU and extract Sensing measurements from the received PPDU while in the Sensing Measurement mode 1604 but unable to process the Data portion of the PPDU (if exists), while other Type 1 STAs and Type 2 STAs may be able to do both e.g., extract Sensing measurements and also properly receive the Data portion of the PPDU, the only difference between Normal Rx mode 1606 and Sensing measurement mode 1604 being the additional step of extraction of Sensing measurements while in the Sensing measurement mode 1604. Yet in other Type 1 STAs and Type 2 STAs, the STAs may be able to extract Sensing measurements from all received PPDUs even in the Normal Rx mode 1606 and hence do not need their PHYs to be explicitly set to the Sensing measurement mode 1604.

If Sensing SPs were negotiated during the Sensing Setup phase, the solicited measurements take place during the Sensing SPs. The measurement Request frame may be a control frame (i.e. frame Type=Control) and typically control frames are not acknowledged. However, when the “Delay Response” field in the measurement request frame is set to 1, and the Responder intends to transmit the Measurement PPDU in a delayed fashion, it will acknowledge the receipt of the frame with an ACK frame to indicate to the Initiator that the Measurement Request frame has been correctly received.

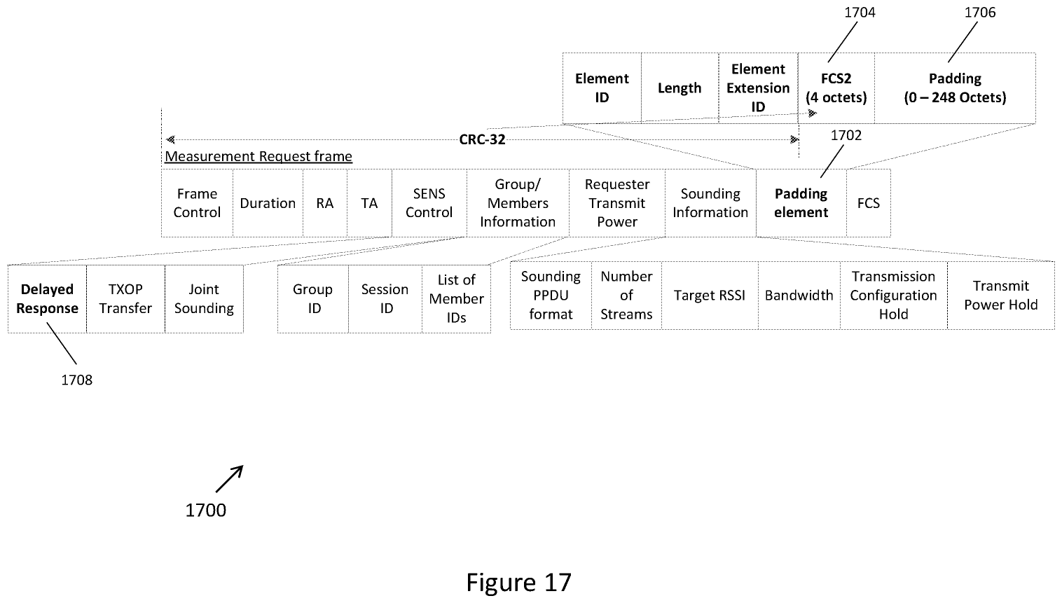

FIG. 17 depicts an illustration of a Measurement Request frame 1700 that may be utilized for solicited measurements in the examples described in FIGS. 15 and 16. The Measurement Request frame 1700 may include a padding element 1702 comprising an Element ID field, Length field, Element Extension ID field, FCS2 field 1704 of 4 octets and a Padding field 1706 of 0-248 octets. The Measurement Request frame 1700 may further comprise, in a SENS Control field, a Delayed Response field 1708. If the Delayed Response field 1708 indicates that delayed response is allowed (e.g., set to 1), a Sensing Responder is allowed to respond to the Measurement Request frame 1700 with an ACK frame and transmit a Measurement PPDU after a delay either in the same TXOP or in the next TXOP.

Alternatively, if the Delayed Response field 1708 indicates that delayed response is not allowed (e.g., set to 0), the Measurement Request frame 1700 may include one or more Padding elements 1702 to provide the Sensing Responder more time to respond with the Measurement PPDU. A Sensing Initiator calculates the amount of padding required based on the “Response Delay” advertised by the Responder. Padding element 1702 is defined such that it carries a 4-octet long FCS2 field 1704 as the first field after the Element Extension ID field and a variable length Padding field 1706 set to a fixed known pattern (e.g., all ones, all zeros, or alternative ones and zeros etc.). The FCS2 field 1704 may further carry a cyclic redundancy code (CRC) that is calculated based on contents of the Measurement Request frame 1700 until the occurrence of the FCS2 field. For example, the FCS2 field 1704 carries a 32-bit CRC-32 calculated over all the fields of the MAC header and the frame body field except the FCS2 field 1704 itself, the Padding field 1706 and the FCS field (e.g. Frame Control field, Duration field, RA field, TA field, SENS field, Groups/Members Information field, Request Transmit Power field, Sounding Information field, Element ID field, Length field and Element Extension ID field are included in the calculation for the 32-bit CRC-32). In order to ensure the integrity of the CRC-32, it has to be ensured that no further changes to the portion of the frame covered by the CRC-32 calculation (either by MAC or PHY) are made once the CRC-32 has been set in the FCS2 field 1704.

The Padding element 1702 may be included in any management frame or suitable control frames and if included in a frame, the Padding element(s) shall be the last element(s) in the frame. A receiving STA, upon receiving the first Padding element, may discard the rest of the frame body after verifying the FCS2 field.

The Measurement Request frame 1700 may also be known as a Sounding Request frame. Usually, Information elements are only carried in Management frames as per the 802.11 specification, and the Padding element in the current example can be carried in a control frame as well e.g., in the Measurement Request frame. Alternatively, the padding element may be replaced by a padding field with a length subfield, a 4 octet FCS2 subfield 1704 and a variable size padding subfield, the length subfield indicating the number of octets in the padding subfield plus four (for the FCS2 field).

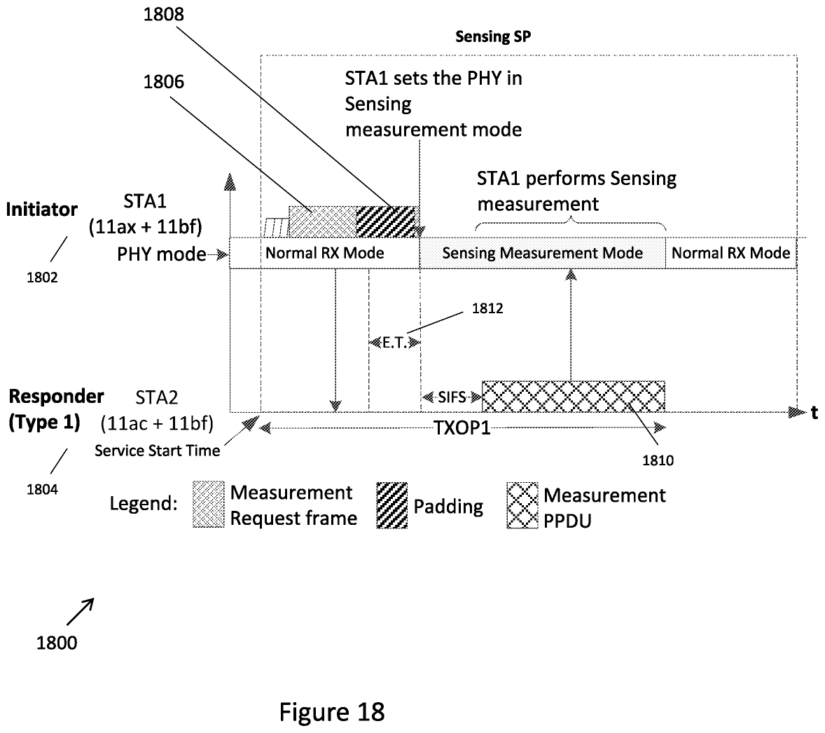

FIG. 18 depicts an illustration of a solicited measurement using a Measurement Request frame 1806 with padding 1808, such as Measurement Request frame 1700. Initiator 1802 is a Type 2 STA, STA1 (11ax+11bf) and Responder 1804 is a Type 1 STA, STA2 (11ac+11bf). When Sensing SPs have been negotiated, STAs that are members of the SP are expected to be in an awake state (e.g., not in power save doze state) at the start of the Sensing SP. The advantage of using padding instead of delayed response is that Measurement PPDU 1810 can be transmitted within the same TXOP and so reduces the time that the Initiator's PHY needs to stay in the Sensing Measurement mode. For example, E.T. 1812 represents the extra time available to the responder, starting from the detection of the Padding element and verifying the FCS2 field, to prepare for transmission of the Measurement PPDU 1810. In this example, if the STA roles are reversed, i.e., if the Initiator 1802 is a Type 1 STA with legacy PHY (e.g. STA2) and the Responder 1804 is a Type 2 STA (e.g. STA1), minimal or no padding may be required in the Measurement Request frame 1806 since the newer PHYs may be able to respond with the Measurement PPDU 1810 without any delay.

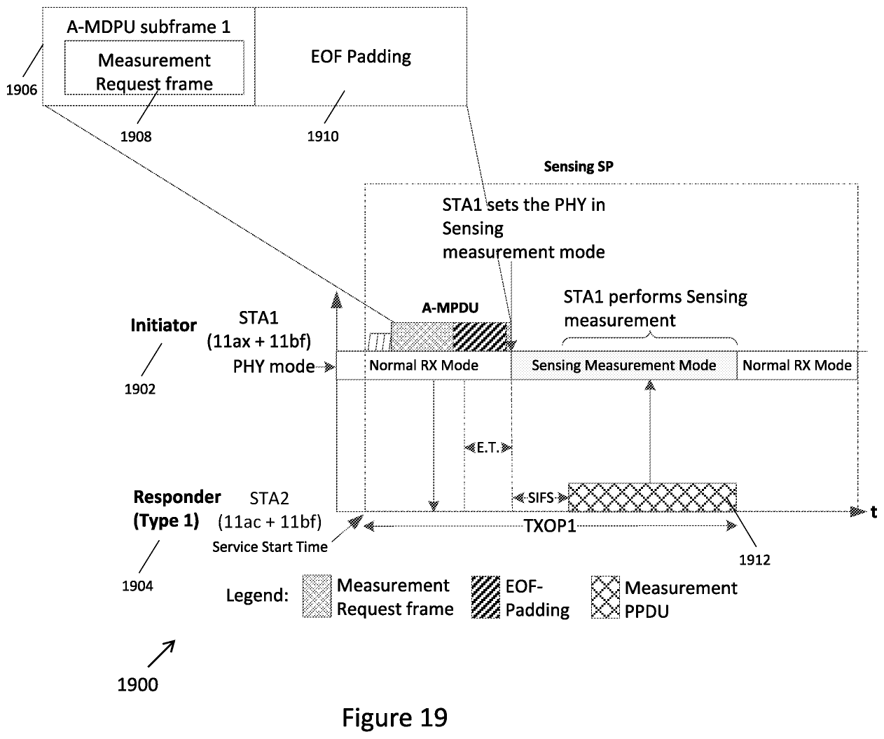

Alternatively, referring to FIG. 19, Measurement Request frame 1908 (without any padding) may be transmitted by Initiator 1902 as a first MPDU in an A-MPDU 1906, and subsequent MPDUs could be dummy MPDUs or end of frame (EOF)-Padding field 1912 acting as padding for Responder 1904. Upon receiving the Measurement Request frame 1908, the Responder 1904 can proceed to prepare the PHY for transmission of Measurement PPDU 1914 and discard the rest of the A-MPDU contents.

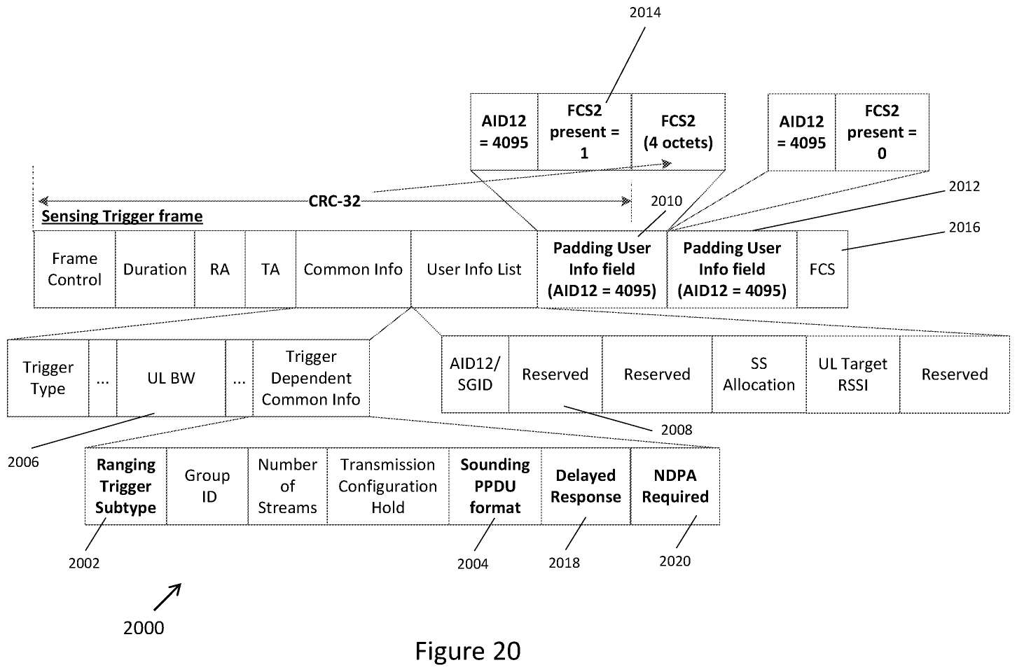

Alternatively, a new Ranging Trigger subtype (based on the 802.11az Ranging Trigger frame) may be defined as a Measurement Request frame as shown in FIG. 20. The Ranging trigger subtype field 2002 in the Trigger frame 2000 may indicate a new subtype value (e.g. 5) that may be used to indicate that the Trigger frame 2000 is a Sensing Trigger frame. Trigger frames were originally introduced in 802.11ax to allocation Resource units (RU) for uplink orthogonal frequency-division multiple access (OFDMA) transmissions, but when the Sounding PPDU format field 2004 indicates HT or VHT, the Sensing Trigger frame solicits a single HT or VHT NDP that occupy the whole bandwidth indicated in the UL BW sub-field 2006. RU Allocation field 2008 is reserved when the Sounding PPDU format field 2004 indicates HT or VHT. Further, the Sensing Trigger frame 2000 may include one or more Padding User Info fields 2010 and 2012 to provide an associated Sensing Responder more time to respond with a Measurement PPDU. A Sensing Initiator calculates the amount of padding required based on the “Response Delay” advertised by the Responder. The first Padding User Info field 2010 may also carry a FCS2 field 2014. The FCS2 field 2014 may carry a 32-bit CRC-32 calculated over all the fields of the MAC header and the frame body field except the FCS2 field 2014 itself and any subsequent padding user info field (e.g. Padding User Info field 2012) and FCS field 2016. If Delayed Response field 2018 is set (e.g., to 1), the Sensing Responder is allowed to respond to the Measurement Request frame with an ACK frame and transmit the Measurement PPDU after a delay either in a same TXOP or in a next TXOP. The Sensing Trigger frame may also indicate, in the NDPA Required field 2020, whether a NDPA frame is required to precede SIFS prior to the Measurement PPDU.

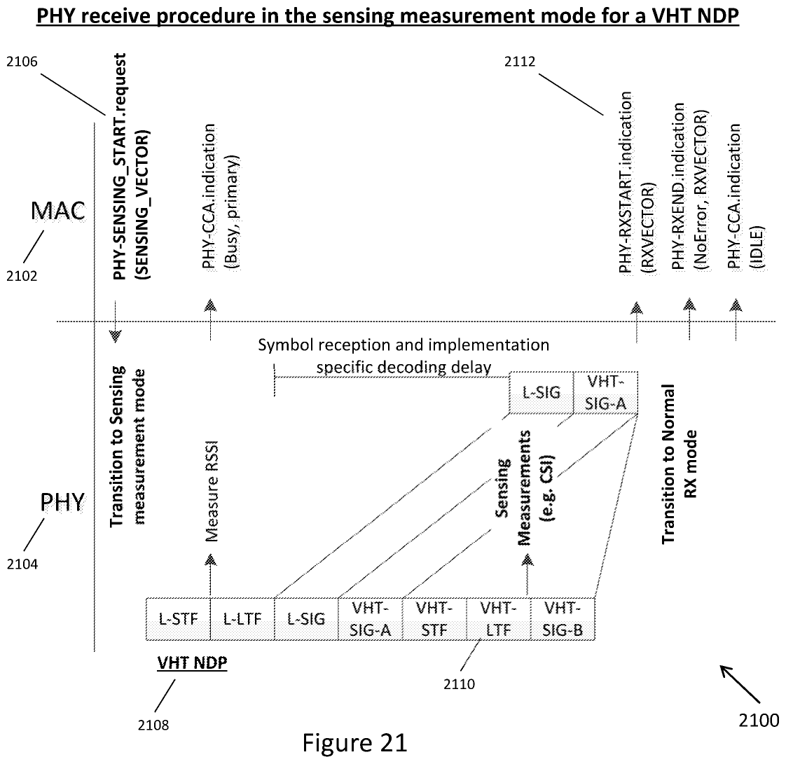

FIG. 21 depicts an illustration of a PHY receive procedure in sensing measurement mode for a VHT NDP in accordance with the first embodiment, wherein an example PHY receiver procedure for receiving sensing measurements (e.g., CSI) when PHY 2104 is in the sensing measurement mode is shown. MAC 2102 issues a PHY-SENSING_START.request primitive 2106 to the PHY 2104 to switch the PHY 2104 to the Sensing measurement mode. Upon receiving measurement PPDU 2108 (e.g., a VHT NDP), the PHY 2104 extracts the sensing measurements from non-legacy LTF 2110 (e.g., VHT LTFs) and pass them to the MAC 2102 in a RXVECTOR parameter of a PHY-RXSTART.indication primitive 2112. The PHY 2104 may automatically transition back to Normal RX mode at the end of the PPDU 2108, or upon expiry of an indicated timeout duration, or upon receipt of another PHY primitive (e.g., PHY-SENSING_STOP.request) that is defined for the purpose. In actual implementations, when the MAC issues the PHY-SENSING_START.request primitive to the PHY 2104 to switch the PHY 2104 to the Sensing measurement mode, some hardware registers may be set to a known value making the PHY 2104 aware that CSI extraction is to be performed for any received PPDU. Similarly, the passing of the sensing measurement results (e.g., CSI or beamforming feedback matrix etc.) from the PHY 2104 to the MAC 2102 may be achieved by writing the results to some table/buffer that are accessible to both the PHY 2104 and the MAC 2102.

The following PHY-SENSING_START.request primitive is issued by the MAC sublayer to the local PHY entity to cause the PHY to transition to the Sensing measurement mode:

PHY-SENSING_START.request (SENSING_VECTOR)
Upon receipt of this primitive, the PHY transitions to the Sensing measurement mode. The parameter in (SENSING_VECTOR) are as shown in Table 2 below:

TABLE 2

| Name | Type | Valid range | Description |
|---|---|---|---|
| PPDU_FORMAT | Enumeration | HT, VHT, HE, | Indicates the format of the |
| | | SECURE_HE, EHT | expected Measurement PPDU. |
| | | | The PHY may ignore other |
| | | | PPDU format. |
| CHAN_MAT_TYPE | Enumeration | COMPRESSED_SV, | Indicates format used for the |
| | | NON_COMPRESSED_SV, | CHAN_MAT parameter in the |
| | | CSI_MATRICES | RXVECTOR: |
| | | | COMPRESSED_SV indicates |
| | | | that CHAN_MAT is a set of |
| | | | compressed beamforming vector |
| | | | matrices. |
| | | | NON_COMPRESSED_SV |
| | | | indicates that CHAN_MAT is a |
| | | | set of noncompressed |
| | | | beamforming vector matrices. |
| | | | CSI_MATRICES indicates that |
| | | | CHAN_MAT is a set of channel |
| | | | state matrices. |
| TIMEOUT_DURATION | Value in | 0-10,000 μS | Timeout duration to return to |
| | microseconds | | Normal RX mode. |

A corresponding PHY-SENSING_START.confirm primitive may also be defined, which is issued by the PHY to the MAC once the PHY has transitioned to sensing measurement mode.

The PHY-SENSING_STOP.request primitive is issued by the MAC sublayer to the local PHY entity to cause the PHY to transition to the Normal RX mode:

PHY-SENSING_STOP.request ( )
Upon receipt of this primitive, the PHY transitions to the Normal RX mode.

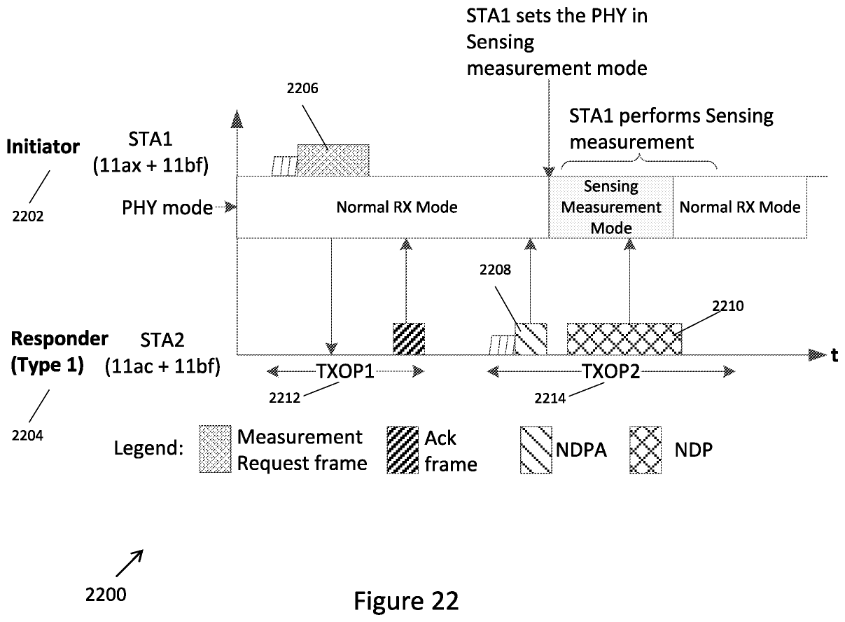

Alternatively, referring to FIG. 22, when delayed response is allowed e.g., if Delayed Response field is set (e.g., to 1) in Measurement Request frame 2206, and Sensing Responder 2204 e.g. STA2 (11ac+11bf) transmits a Measurement PPDU 2210 in a next TXOP (e.g. in TXOP2 2214 instead of TXOP1 2212), the Measurement PPDU 2210 may be preceded by a NDP Announcement (NDPA) frame 2208 e.g. the Sensing Responder 2204 may generate an announcement frame prior to transmitting the measurement PPDU, wherein the announcement frame may be the NDPA frame 2208 addressed to Sensing Initiator 2202 STA1 (11ax+11bf). The NDPA frame 2208 may be transmitted within a fixed duration (e.g., SIFS) prior to transmitting the Measurement PPDU 2210. Whether the NDPA frame is required to precede the NDP may also be indicated in the Measurement request frame, e.g. in the NDPA Required field 2020 in the Sensing Trigger frame 2000 in FIG. 20; if indicated as “required”, the Responder transmits the NDPA frame SIFS prior to the transmission of the NDP. The Sensing Initiator 2202 issues a PHY-SENSING_START.request primitive to its local PHY entity to cause the PHY to transition to Sensing measurement mode only after receiving a valid NDPA frame 2208 addressed to itself. For Responders that are 11n devices, the NDPA frame may be any valid frame carrying a HT Control field in which the HT NDP Announcement subfield is set to 1. In addition, the CSI/Steering subfield of the HT variant HT Control field is set as 0 to indicate that no feedback is required. Advantageously, the Sensing Initiator 2202 need not be in sensing measurement mode for unnecessarily long time.

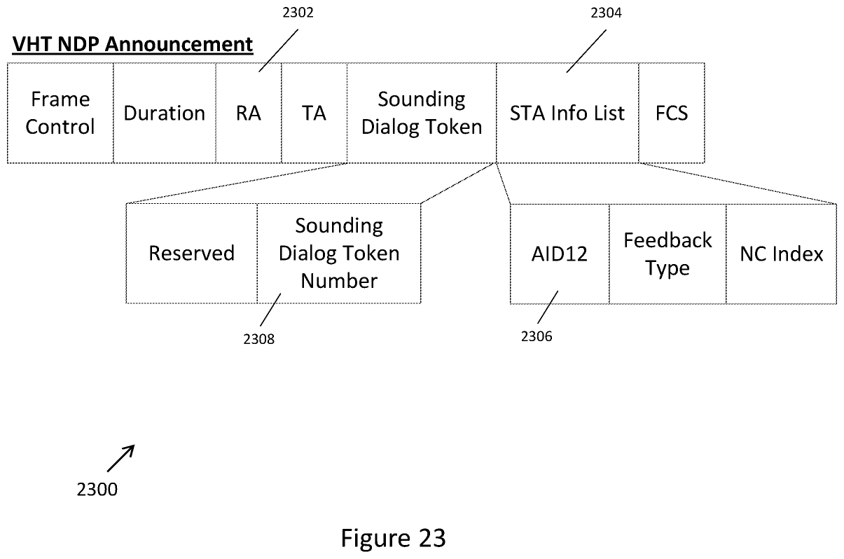

FIG. 23 depicts an illustration of a VHT NDP Announcement (NDPA) frame 2300 which may be used as the NDPA frame 2208 in FIG. 22. The VHT NDPA frame 2300 may comprise a RA field 2302 which may be set to a MAC address of a STA that requested Sensing measurement. If a VHT NDP is returned as a measurement PPDU (in solicited measurement), the preceding NDPA frame (e.g. NDPA frame 2300) may carry a single STA Info field 2304 with the AID12 field 2306 set as a special AID (e.g., 2048) to indicate that no feedback is expected or required from the addressed STA. STAs that receive a VHT NDPA with a single STA Info field that has its AID12 subfield set to the special AID (e.g., 2048) may use the following VHT NDP for its own sensing measurement and shall not respond with the compressed beamforming feedback. If the VHT NDP is used by an AP as a broadcast measurement PPDU in unsolicited measurements that do not require feedback, the preceding NDPA frame (e.g. NDPA frame 2300) may carry a single STA Info field 2304 with the AID12 field 2306 set as a special AID (e.g., 2048) to indicate that no feedback is expected. The RA field 2302 of the NDPA frame 2300 may be set as broadcast address in this case. Although VHT NDPA frame is shown as an example, it will be appreciated that the scenarios described above are equally applicable to HE or EHT NDPA frames that precedes an HE or EHT NDP. For example, the announcement frame may be a VHT, HE or EHT NDPA frame addressed to a communication apparatus (e.g. a Sensing Initiator), the NDPA frame carrying a STA Info field (e.g. STA Info field 2304) with an AID12 field (e.g. AID12 field 2306) set to a known AID value to indicate that the communication apparatus is not expected to transmit a feedback frame. Alternatively, one or more bits of the Sounding Dialog Token Number field 2308 may also be used to indicate that feedback is not expected; or a special value (e.g. 255) may also be defined for the Sounding Dialog Token Number field 2308 to indicate that feedback is not expected. If the Sounding Dialog Token Number field 2308 is used to indicate that feedback is not expected, the AID12 field 2306 of the STA Info field 2304 may carry the AID of the addressed non-AP STA or set to 0 if addressed to an AP.

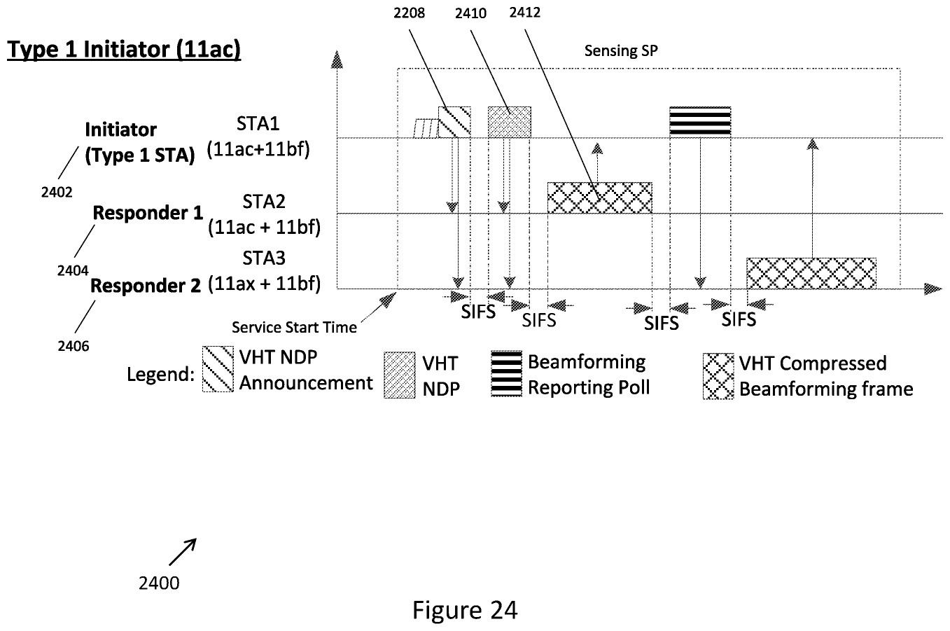

FIG. 24 depicts an illustration of an unsolicited measurement process 2400 with a Type 1 Sensing Initiator 2402 e.g. Type 1 STA1 (11ac+11bf) in accordance with the first embodiment. Sensing Initiator 2402 may transmit a measurement PPDU and Responder 2404 e.g. STA2 (11ac+11bf) may be asked to provide feedback with the sensing measurement result. When Sensing SPs have been negotiated, STAs that are members of the SP, for example Sensing Initiator 2402, Sensing Responder 2404 and Sensing Responder 2406 e.g. STA3 (11ax+11bf), are expected to be in the awake state (e.g., not in power save doze state) at the start of the Sensing SP.

When a Type 1 STA is a Sensing Initiator e.g. Sensing Initiator 2402, it can use the legacy sounding procedure (e.g., VHT beamforming feedback) to obtain Sensing measurements. For example, an 11ac STA such as Initiator 2402 can solicit VHT Compressed beamforming feedback from two Responders 2404 and 2406 by transmitting a VHT NDPA 2408 and a VHT NDP 2410 at the start of a Sensing SP. Upon receiving a compressed beamforming feedback e.g. VHT Compressed Beamforming frame 2412, the Sensing Initiator 2402 can reconstruct the beamforming feedback matrix V as explained in equation (19-79) in IEEE 802.11-2020.

The Sensing Initiator 2402 may use the beamforming feedback matrix V and the SNR information of the subcarriers to compute the channel matrix H i.e., the CSI, or it may simply use the beamforming feedback matrix V as representative of the channel. Alternatively, the Sensing Initiator 2402 can forward the received compressed beamforming feedback matrices to an upper layer sensing app on a same device or even a cloud server for further processing and analysis, the sensing app being responsible for extracting the channel measurement information from the beamforming feedback matrices. However, since the beamforming feedback is in a compressed form, there may be some loss of information when the beamforming feedback matrix V is received from the compressed feedback and the resulting sensing measurement may only be suitable for sensing use cases that do not require high resolution sensing measurements. In this example, the feedback is assumed to be compressed beamforming feedback that is natively supported by 802.11ac, 802.11ax and 802.11be as the feedback for explicit beamforming feedback. However, it is also possible that the legacy sounding mechanism is upgraded such that upon receiving a feedback request (e.g., an NDPA, NDP), instead of responding with a compressed beamforming feedback, the Sensing Responder sends back a feedback frame carrying the CSI matrix (i.e., the original channel measurement results, also known as H) either in raw form or with some form of compression. In this case the NDPA frame 2208 would indicate that CSI feedback is requested, e.g. using one or more bits from the Sounding Dialog Token field as shown in FIG. 23.

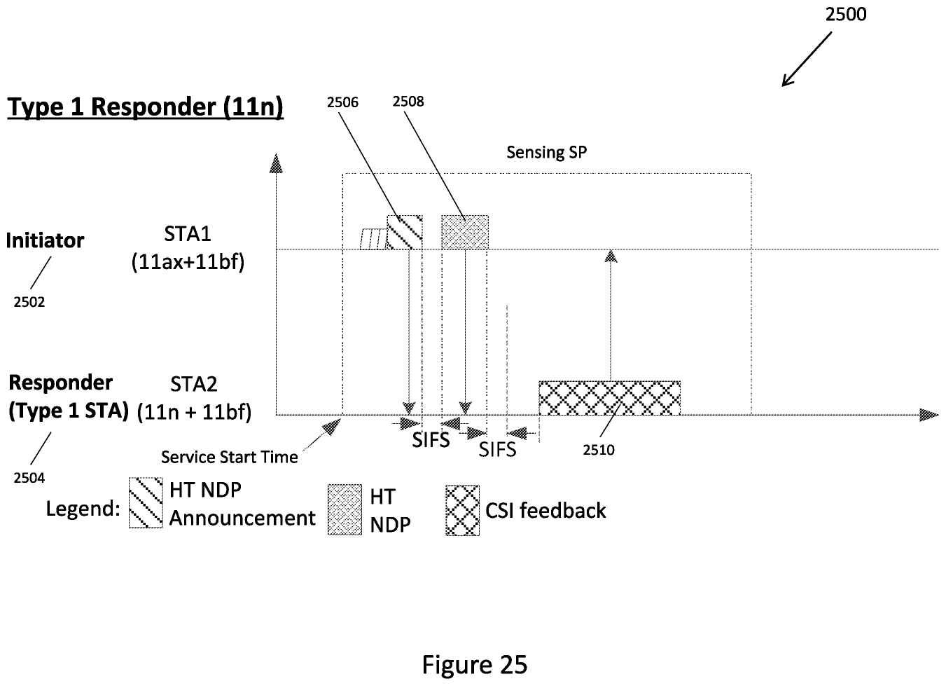

FIG. 25 depicts an illustration of an unsolicited measurement process 2500 with a Type 1 responder 2504 e.g. STA2 (11n+11bf) in accordance with the first embodiment. In this example, a Type 2 Sensing Initiator 2502 e.g. STA1 (11ax+11bf) may transmit a measurement PPDU and the Responder 2504 may be asked to provide feedback with the sensing measurement result. When the Sensing Responder 2504 is a Type 1 STA, the Sensing Initiator 2502 can use legacy sounding procedure to obtain Sensing measurements. E.g., Sensing Initiator 2502 (being an 11ax STA) can solicit HT CSI feedback from the Sensing Responder 2504 (being an 11n STA) by transmitting an HT NDPA 2506 and HT NDP 2508 and soliciting CSI feedback 2510. Alternatively, non-compressed/compressed beamforming feedback matrices can also be solicited from an 11n STA.

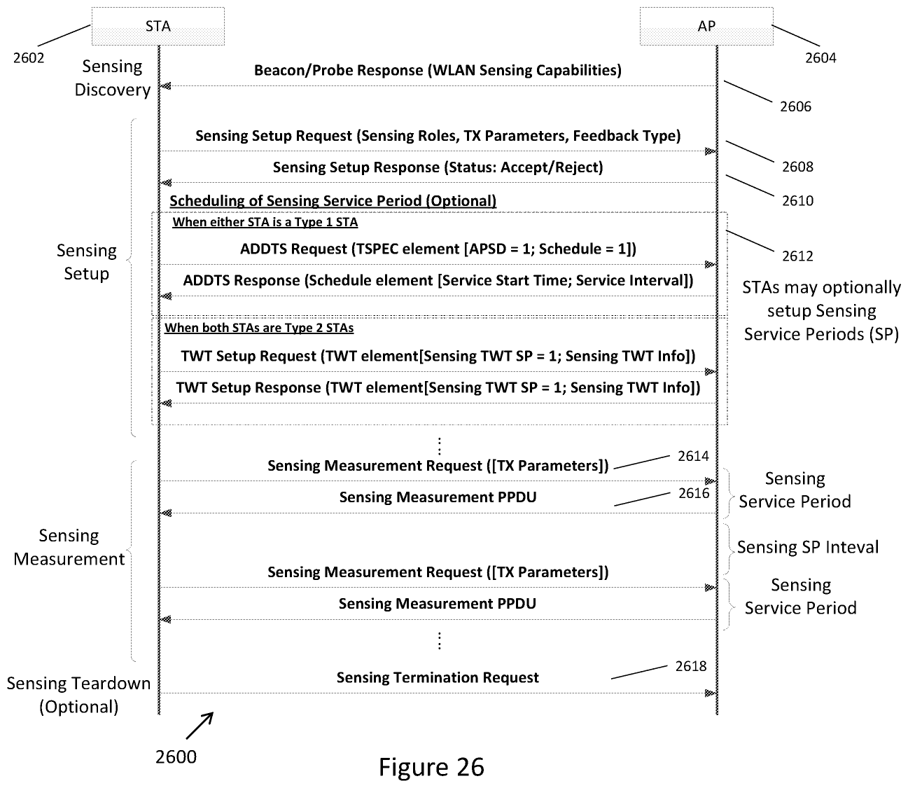

FIG. 26 depicts an illustration 2600 of a sensing phase summary in accordance with the first embodiment, which shows an example flow for WLAN Sensing phases using solicited measurements with a non-AP STA 2602 as the Sensing Initiator/Receiver and an associated AP 2604 as the Sensing Responder/Transmitter. At step 2606, a Beacon/Probe Response advertising WLAN Sensing Capabilities is transmitted by the AP 2604. While not shown in FIG. 26, the non-AP STA 2602 also indicates its WLAN Sensing capabilities to the AP 2604 during the association procedure by including its WLAN Sensing capabilities in the Association Request frame. At step 2608, a Sensing Setup Request comprising information of sensing roles, TX parameters and feedback type is transmitted by the STA 2602 to the AP 2604. At step 2610, a Sensing Setup Response including a status information of whether the Sensing Setup Request is accepted or rejected is transmitted from the AP 2604 to the STA 2602. The Setup Request/Response frames may also include the WLAN Sensing capabilities of the participating STAs.

In an optional step 2612, scheduling of Sensing SP may be performed. When either STA 2602 or AP 2604 is a Type 1 STA, an ADDTS Request including a TSPEC element indicating, for example, APSD=1 and Schedule=1, is transmitted from the STA 2602 to the AP 2604. An ADDTS Response including a Schedule element indicating a Service Start Time and a Service Interval is then transmitted from the AP 2604 to the STA 2602. On the other hand when both STA 2602 and AP 2604 are Type 2 STAs, a TWT Setup Request including a TWT element indicating, for example, Sensing TWT SP=1 and including Sensing TWT information, is transmitted from the STA 2602 to the AP 2604. A TWT Setup Response including a TWT element indicating, for example, Sensing TWT SP=1 and including Sensing TWT information, is transmitted from the AP 2604 to the STA 2602.

In a step 2614, a Sensing Measurement Request comprising transmission parameters is transmitted from the STA 2602 to the AP 2604. In a step 2616, a Sensing Measurement PPDU (e.g., an NDP, or a PPDU carrying a Data frame, or a PPDU carrying a dedicated Management frame defined for sensing etc.) is transmitted from the AP 2604 to the STA 2602. Steps 2614 and 2616 are performed within each Sensing SP, wherein each Sensing SP is separated from a next Sensing SP by a Sensing SP Interval. In an optional step 2618, the STA 2602 transmits a Sensing Termination Request to the AP 2604 for teardown of the sensing session.

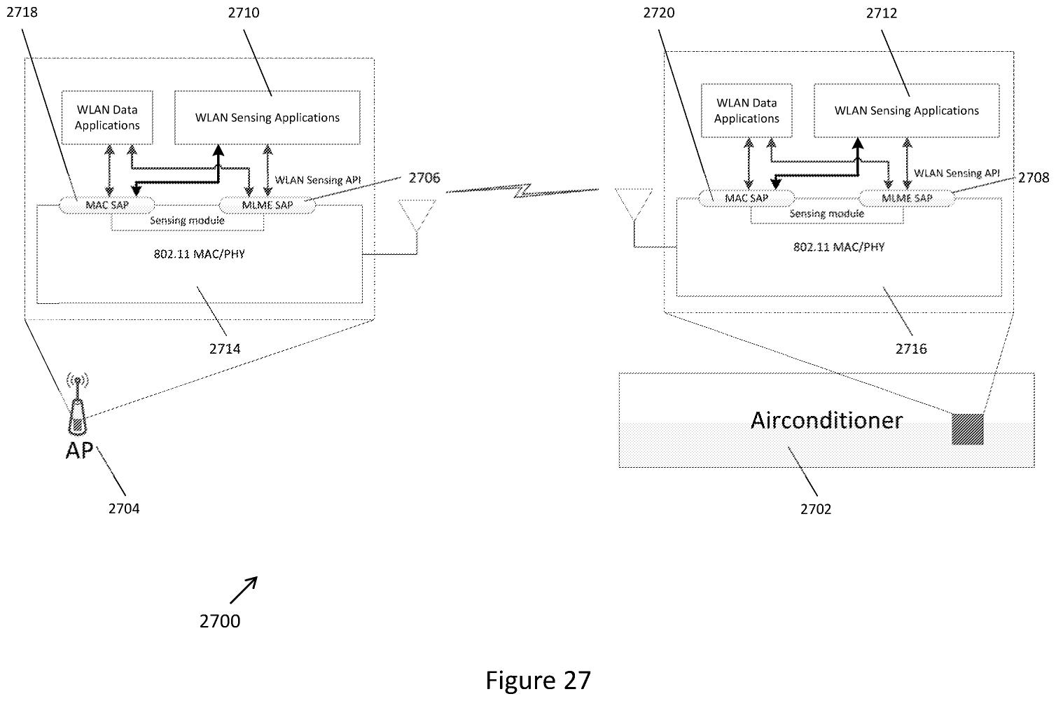

A second embodiment E2 places focus on Type 1 STAs that support minimal changes to the MAC and MAC-PHY interfaces. For example, in WLAN Sensing deployment illustration 2700 in FIG. 27 with two Type 1 Sensing STAs (e.g. Air conditioner 2702 and AP 2704) in accordance with the second embodiment, minimal changes may be made to the MLME SAP 2706 and 2708 (e.g. Management plane). Most of the WLAN Sensing intelligence is assumed to be maintained in the WLAN Sensing application e.g. WLAN Sensing Applications 2710 and 2712 that sit above the MAC 2714 and 2716 respectively. While Sensing Setup may be performed using Management frames, Sensing measurements may be performed using Sensing Application commands carried in Data frames (i.e., over MAC SAP 2718 and 2720).

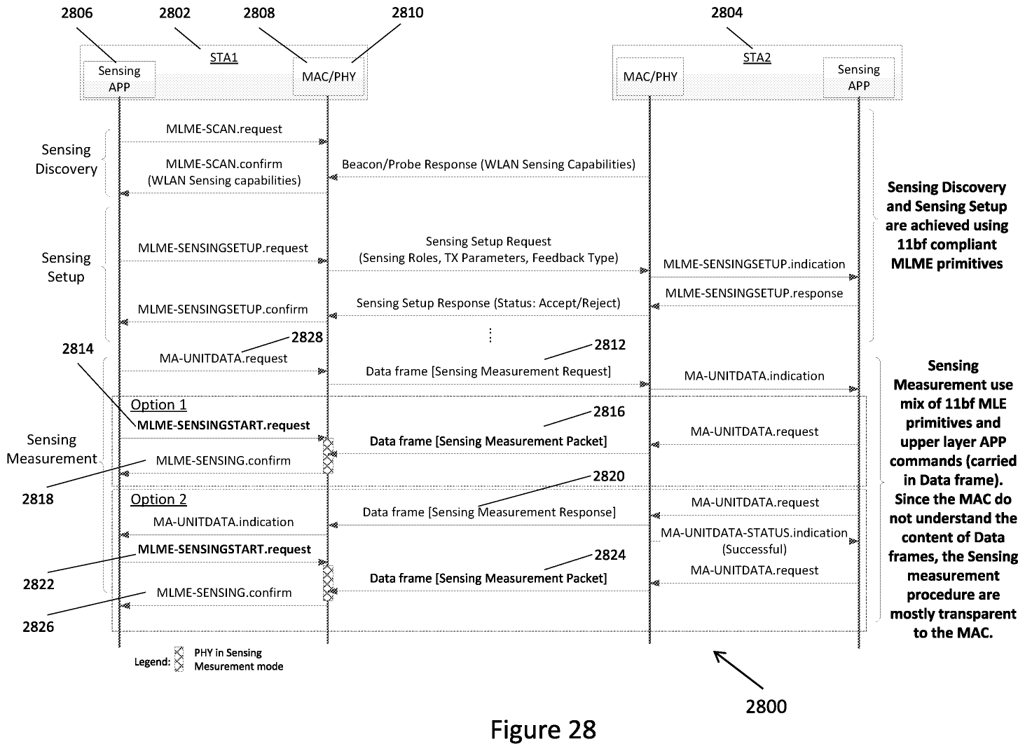

FIG. 28 depicts an illustration 2800 of example sensing measurements using Data frame as Measurement PPDUs in accordance with the second embodiment. In this example, Sensing discovery and Sensing Setup are achieved using 11bf compliant MLME primitives. While dedicated 11bf Management frames are used during Sensing Setup phase, during Sensing Measurement phase, Data frames carrying upper layer Sensing APP's commands as payload are used during the Sensing Measurement phase. Sensing Measurement may use a mix of 11bf MLME primitives and upper layer APP commands (e.g. carried in Data frames). Since MAC do not understand the content of Data frames, the Sensing Measurement procedure are mostly transparent to the MAC.

Furthermore, in FIG. 28, Data frame (xxx) indicates that the Sensing APP's (xxx) command is carried in the Data frame as payload and is transported to the Sensing APP running on the peer STA (for example, Data frame (Sensing Measurement Request) 2812 indicates that the Sensing APP's (Sensing Measurement request) command is carried in the Data frame 2812 as payload and is transported to the Sensing APP running on the peer STA which is STA2 2804). In addition, PPDUs carrying Data frames are also used as measurement PPDUs. In that sense, the measurement phase may be transparent to the MAC layer of the Type 1 STAs except for the times when the PHY is instructed to switch to sensing measurement mode.

Sensing Measurement phase as shown in FIG. 28 proceeds as follows. WLAN Sensing APP 2806 issues a MA-UNITDATA.request 2828 to trigger the transmission of a Data frame carrying the Sensing APP's Sensing Measurement Request command 2812. WLAN Sensing APP 2806 issues a MLME-SENSINGSTART.request primitive 2814 or 2822 to MAC 2808 to prepare the device e.g. STA1 2802 for sensing measurements. Upon receiving the MLME-SENSINGSTART.request primitive 2814 or 2822, the MAC 2808 will in turn trigger a PHY-SENSING_START.request primitive to put PHY 2810 in the sensing measurement mode. The PHY 2810 moves back to normal RX mode upon completion of reception of the Measurement PPDU e.g. Data frame (Sensing Measurement Packet) 2816 or 2824 in this example. Upon completing the sensing measurement, the MAC 2808 issues the MLME-SENSING.confirm primitive 2818 or 2826 to the Sensing App 2806 to pass the result of the sensing measurements.

In an Option 1, the Sensing Initiator e.g. STA1 2802's Sensing APP issues the MLME-SENSINGSTART.request primitive 2818 to put the PHY 2810 in sensing measurement mode immediately after receiving an ACK frame to Data frame (Sensing Measurement Request) 2812 (e.g. the Data frame carrying the Sensing APP's Sensing Measurement Request command) and waits for the Sensing Responder e.g. STA2 2804 to transmit the Data frame to be used as Measurement PPDU e.g. Data frame (sensing Measurement Packet) 2816.

In an Option 2, after the Sensing Initiator 2802 transmits the Data frame 2812 carrying the Sensing APP's Sensing Measurement Request command, it will wait for the responder's Data frame 2820 carrying the Sensing APP's Sensing Measurement Response command. Only after receiving the Sensing Measurement Response command, the Sensing APP 2802 will issue the MLME-SENSINGSTART.request primitive 2822 to put the PHY 2810 in sensing measurement mode. The Responder 2804 will transmit Data frame 2824 to be used as Sensing measurement PPDU only after confirming that the Data frame 2820 carrying the Sensing APP's Sensing Measurement Response command was successfully delivered to the Sensing Initiator 2802. Option 2 advantageously helps to minimize the time that the Sensing Initiator's PHY 2810 need to be in the sensing measurement mode and hence is more attractive to Type 1 STAs that may not be able to perform regular RX operation when the PHY is in the Sensing Measurement mode.

In this example, it is assumed that the MAC of the sensing receiver is aware when sensing measurement is being conducted (e.g., upon receiving the MLME-SENSINGSTART.request primitive) and hence even though Data frames are used as measurement PPDUs, it can intercept any such sensing measurement results received from the PHY during this time period and correctly issue the MLME-SENSING.confirm primitive to the Sensing APP to pass the sensing measurement results.

As shown in the example of FIG. 28, the MLME-SENSINGSTART.request primitive is issued to the MAC sublayer to prepare the device for sensing measurements. Upon receiving the MLME-SENSINGSTART.request primitive, the MAC will in turn trigger the PHY-SENSING_START.request primitive to put the PHY in the sensing measurement mode. The MLME-SENSINGSTART.request primitive may be presented as MLME-SENSINGSTART.request (SENSING_VECTOR), wherein the parameters of the SENSING_VECTOR are as shown in Table 3 below:

TABLE 3

| Name | Type | Valid range | Description |
|---|---|---|---|
| PPDU_FORMAT | Enumeration | HT, VHT, HE, | Indicates the format of the |
| | | SECURE_HE, EHT | expected Measurement PPDU. |
| | | | The PHY may ignore other |
| | | | PPDU formats. |
| CHAN_MAT_TYPE | Enumeration | COMPRESSED_SV, | Indicates format used for the |
| | | NON_COMPRESSED_SV, | CHAN_MAT parameter in the |
| | | CSI_MATRICES | RXVECTOR: |
| | | | COMPRESSED_SV indicates |
| | | | that CHAN_MAT is a set of |
| | | | compressed beamforming vector |
| | | | matrices. |
| | | | NON_COMPRESSED_SV |
| | | | indicates that CHAN_MAT is a |
| | | | set of noncompressed |
| | | | beamforming vector matrices. |
| | | | CSI_MATRICES indicates that |
| | | | CHAN_MAT is a set of channel |
| | | | state matrices. |
| TIMEOUT_DURATION | Value in | 0-10,000 μS | Timeout duration to return to |
| | microseconds | | Normal RX mode. |

A corresponding MLME-SENSING.confirm primitive is also defined, which is issued by the MAC to upper layer upon receiving confirmation from the PHY that it has transitioned to sensing measurement mode. There may however exist receivers that automatically extract CSI for all received PPDUs (i.e., even in normal RX mode) and stores them in temporary tables/buffer (e.g., in CSI_TABLE) in the PHY until they are overwritten when the next PPDU is received; and hence do not require the PHY-SENSING_START.request primitive to switch the PHY to the sensing measurement mode. In such devices, upon receiving the MLME-SENSINGSTART.request primitive, the MAC waits until the PHY indicates that a PPDU has been received successfully; upon checking that the PPDU is indeed a correct measurement PPDU (e.g., transmitted by the expected peer STA, carrying the expected payload such as a certain type of frame etc., the MAC may issue the PHY primitive PHY-CSI_RECEIVE.request (CSI_PARAMETER) to instruct the PHY to pass up the collected sensing measurement to the MAC (e.g. in the PHY-CSI_RECEIVE.confirm(CSI_MATRIX) primitive). The CSI_PARAMETER may carry the CHAN_MAT_TYPE parameter that specify the format in which to pass the measurement results to the MAC. Upon receiving the PHY-CSI_RECEIVE.request primitive, the PHY passes the content of the CSI_TABLE to the MAC in the specified format, e.g., in the CSI_RECEIVE.confirm primitive.

If PPDUs carrying Data frames are used as Measurement PPDUs, the Sensing APP may indicate this in the MA-UNITDATA.request primitive and may also pass related transmission parameters.

MA-UNITDATA.request (
source address
...
SENSING_PARAMS
)

The parameter of the SENSING_PARAMS are as shown in Table 3A:

TABLE 3A

| Name | Type | Valid range | Description |
|---|---|---|---|
| PPDU_FORMAT | Enumeration | HT, VHT, HE, | Indicates the format of the |
| | | SECURE_HE, EHT | expected Measurement PPDU. |
| | | | The PHY may ignore other |
| | | | PPDU formats. |
| Beamformed | Boolean | Yes, No | Indicates whether the PPDU |
| | | | carrying the Data frame may be |
| | | | beamformed or not. |
| TX_PARAMS | Structure | | Carries transmission parameters |
| | | | relevant for the Sensing |
| | | | Measurement PPDU; e.g., Q |
| | | | Matrix to be used if the PPDU is |
| | | | to be beamformed; number of |
| | | | LTFs, channel bandwidth etc. |

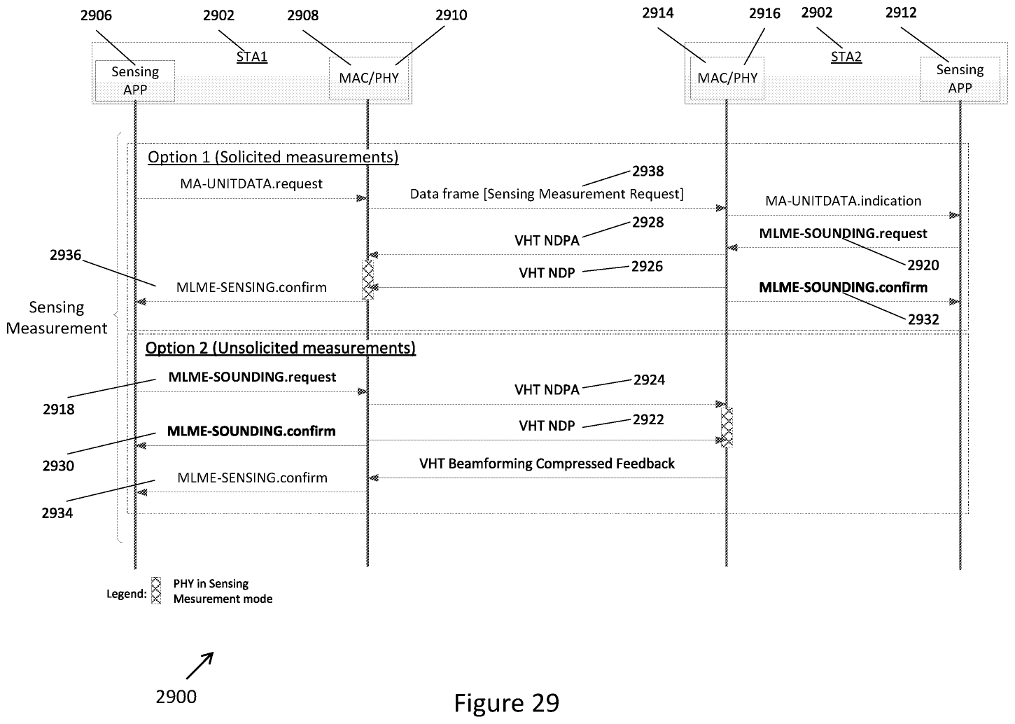

Alternately, Sensing measurement phase may use Sounding PPDUs as Measurement PPDUs as shown in FIG. 29 according to the second embodiment. WLAN Sensing APP (e.g. Sensing APP 2906 and 2912) may issue a MLME-SOUNDING.request primitive (e.g. MLME-SOUNDING.request primitive 2918 and 2920 respectively) to the MAC (e.g. MAC 2908 and 2914 respectively) to trigger transmission of NDP and optionally NDPA (e.g. VHT NDP 2922/VHT NDPA 2924, and VHT NDP 2926/VHT NDPA 2928 respectively). Upon receiving the MLME-SOUNDING.request primitive, the MAC will in turn trigger a PHY-TXSTART.request primitive to trigger the transmission of the NDPA and NDP. In Option 1 (Solicited Measurements), the MLME-SOUNDING.request primitive 2920 is issued by the Sensing APP 2912 of the Sensing Responder 2902 upon receiving a Sensing Measurement Request command (e.g. carried in a Data frame 2938), and the VHT NDPA 2928 indicates that feedback is not required. While in Option 2 (Unsolicited Measurements), the MLME-SOUNDING.request primitive 2918 is issued by the Sensing APP 2906 of the Sensing Initiator 2902 itself and the VHT NDPA 2924 indicates that feedback is required.

Upon completion of the NDP transmission, the MAC (e.g. MAC 2908 and 2914) issues a MLME-SOUNDING.confirm primitive (e.g. MLME-SOUNDING.confirm primitive 2930 and 2932 respectively) to the Sensing App (e.g. Sensing APP 2906 and 2912 respectively) to inform the transmission status of the NDP.

Upon completing the sensing measurement (either performed by itself upon receiving an NDP, or upon receiving a feedback report from the peer STA), the MAC (e.g. MAC 2908 and 2914) issues a MLME-SENSING.confirm primitive (e.g. MLME-SENSING.confirm primitive 2934 and 2936 respectively) to the Sensing App (e.g. Sensing APP 2906 and 2912 respectively) to pass the result of the sensing measurements.

When sounding PPDUs are used as sensing measurement PPDU, the MAC (e.g. MAC 2908 and 2914) will automatically trigger the PHY-SENSING_START.request primitive to put the PHY (e.g. PHY 2910 and 2916) in the sensing measurement mode upon receiving a valid NDPA frame (e.g. VHT NDPA 2924 and VHT NDPA 2928 respectively). The PHY moves back to normal RX mode upon completion of reception of the NDP (e.g. VHT NDP 2922 and VHT NDP 2926 respectively).

The MLME-SOUNDING.request primitive issued to the MAC sublayer to transmit an NDP and optionally a preceding NDPA in the example of FIG. 29 may be presented as MLME-SOUNDING.request (SOUNDING_VECTOR). Upon receipt of this primitive, the PHY transmits an NDP and optionally a preceding NDPA. The parameter of the SOUNDING_VECTOR may be as shown in Table 4 below:

TABLE 4

| Name | Type | Valid range | Description |
|---|---|---|---|
| PPDU_FORMAT | Enumeration | HT, VHT, HE, | Indicates the format of |
| | | SECURE_HE, EHT | the NDP (and NDPA) |
| | | | to be transmitted. |
| NDPA_REQUIRED | Enumeration | YES, NO | Indicates whether an |
| | | | NDPA shall precede |
| | | | the NDP. |
| Number of Streams | Integer | 0-16 | Number of space time |
| | | | streams to be used for |
| | | | the NDP. |
| Bandwidth | Integer | 1-16 | Indicates the channel |
| | | | bandwidth to be used |
| | | | for the NDP. |
| Peer STA MAC | MAC Address | Any valid MAC | If NDPA_REQUIRED |
| Address | | Address | is YES, carries the |
| | | | MAC Address to be |
| | | | used for the RA |
| | | | (Address 1) field of the |
| | | | NDPA. |
| STA_INFO_LIST | Structure | | If NDPA_REQUIRED |
| | | | is YES, carries the |
| | | | content of the STA Info |
| | | | List field of the NDPA. |

The MLME-SOUNDING.confirm primitive issued by the MAC sublayer to the upper layer to inform the status of the NDP transmission may be presented as MLME-SOUNDING.confirm (STATUS, Peer STA MAC Address). The primitive is issued by the MAC upon receipt of a second PHY-TXEND.confirm primitive from the PHY (e.g. corresponding to the NDP). The STATUS carries the status that the MAC sublayer provides to the upper layer related to the transmission of the NDP (and optionally the NDPA). If NDPA was transmitted, Peer STA MAC Address carries the MAC Address used for the RA (Address 1) field of the NDPA.

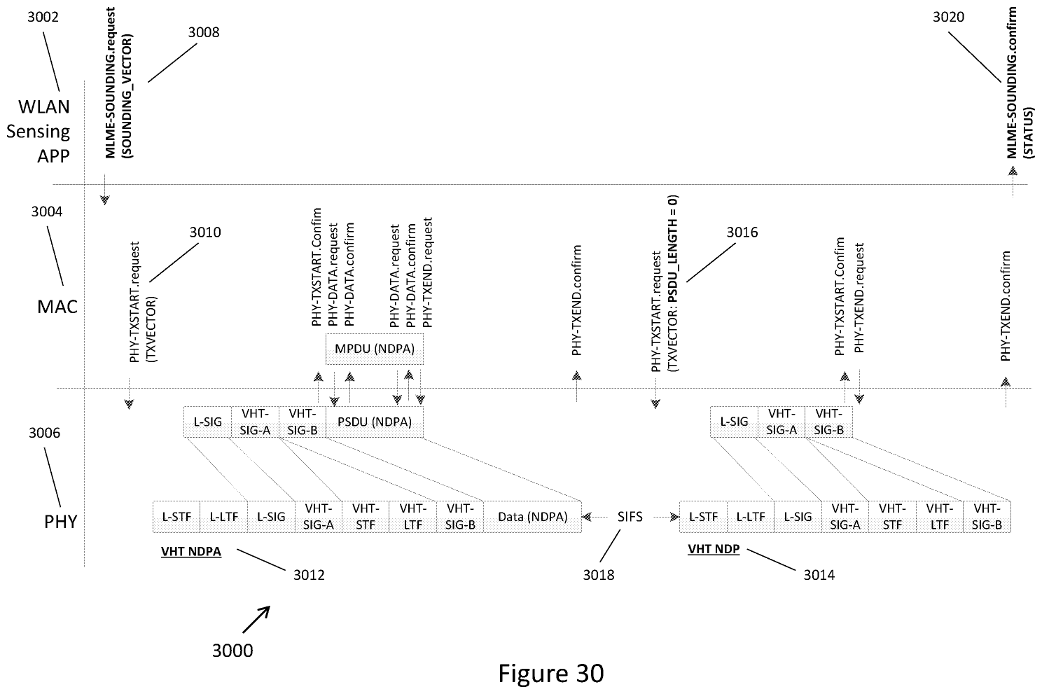

FIG. 30 depicts an illustration of an example transmit procedure 3000 for a VHT sounding sequence in accordance with the second embodiment. WLAN Sensing APP 3002 issues a MLME-SOUNDING.request (SOUND_VECTOR) primitive 3008 to MAC 3004 to trigger the transmission of VHT NDPA 3012 and VHT NDP 3014.

Upon receiving the MLME-SOUNDING.request (SOUND_VECTOR) primitive, the MAC 3004 will in turn trigger PHY-TXSTART.request (TXVECTOR) primitive 3010 to PHY 3006 to trigger the transmission of the VHT NDPA 3012. Further, a PHY-TXSTART.request primitive is issued to the PHY 3006 with the TXVECTOR parameter PSDU_LENGTH set to 0 (e.g. PHY-TXSTART.request(TXVECTOR:PSDU_LENGTH=0) 3016), within SIFS 3018 from the end of transmission of the preceding NDPA 3012, to initiate the transmission of the VHT NDP 3014. Upon completion of the NDP transmission, the MAC 3004 issues the MLME-SOUNDING.confirm(STATUS) primitive 3020 to the Sensing App 3002 to inform the transmission status.

In a third embodiment E3, it is considered that Type 1 STAs that do not support any changes to the MAC and MAC-PHY interfaces and all the WLAN Sensing intelligence is maintained in the WLAN Sensing application that sits above the MAC. No changes are made to the MLME SAP (Management plane). All Sensing Operations are performed using Sensing Application commands carried in Data frames (i.e., over MAC SAP) and via proprietary WLAN Sensing API e.g. a measurement request frame may be a data frame carrying a measurement request Sensing Application command i.e., Sensing Application commands are encapsulated within Data frames.

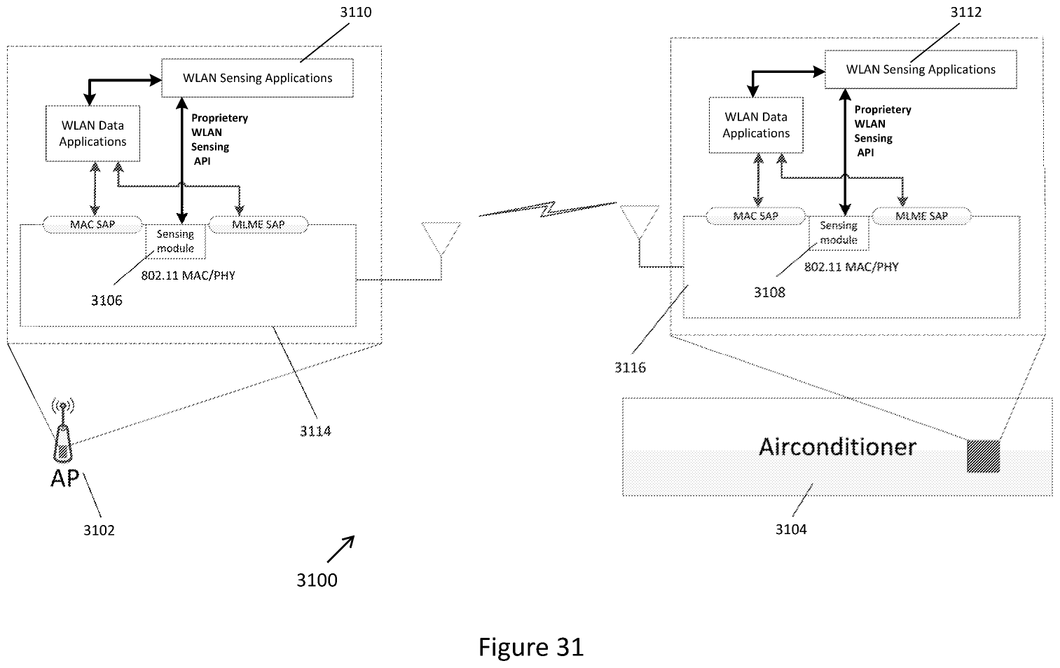

FIG. 31 depicts an illustration 3100 of an example WLAN sensing deployment with two Type 1 Sensing STAs (e.g. AP 3102 and Air conditioner 3104) in accordance with the third embodiment as explained above. In this case, Sensing Modules 3106 and 3108 may be a very light layer sitting in a 802.11 Upper MAC or above a 802.11 MAC and provides an interface between WLAN Sensing application (e.g. WLAN Sensing application 3110 and 3112 respectively) and the 802.11 MAC/PHY (e.g. 802.11 MAC/PHY 3114 and 3116 respectively). For example, it may help to translate proprietary Sensing App command PRPTY-SENSINGSTART.request to an appropriate 802.11 vendor specific API to put the 802.11 PHY (e.g. the 802.11 PHY in 802.11 MAC/PHY 3114 and 3116 respectively) in sensing measurement mode to prepare the PHY to receive Sensing measurement PPDUs. Similarly, once the PHY/MAC (e.g. 802.11 MAC/PHY 3114 and 3116 respectively) receive the Sensing measurement PPDU, the sensing module (e.g. Sensing Modules 3106 and 3108 respectively) helps to translate the sensing measurement results (e.g., CSI) in a format understood by the WLAN Sensing application (e.g. WLAN Sensing application 3110 and 3112 respectively), and triggers a PRPTY-SENSING.confirm Sensing app command to forward the results to the WLAN Sensing application (e.g. WLAN Sensing application 3110 and 3112 respectively).

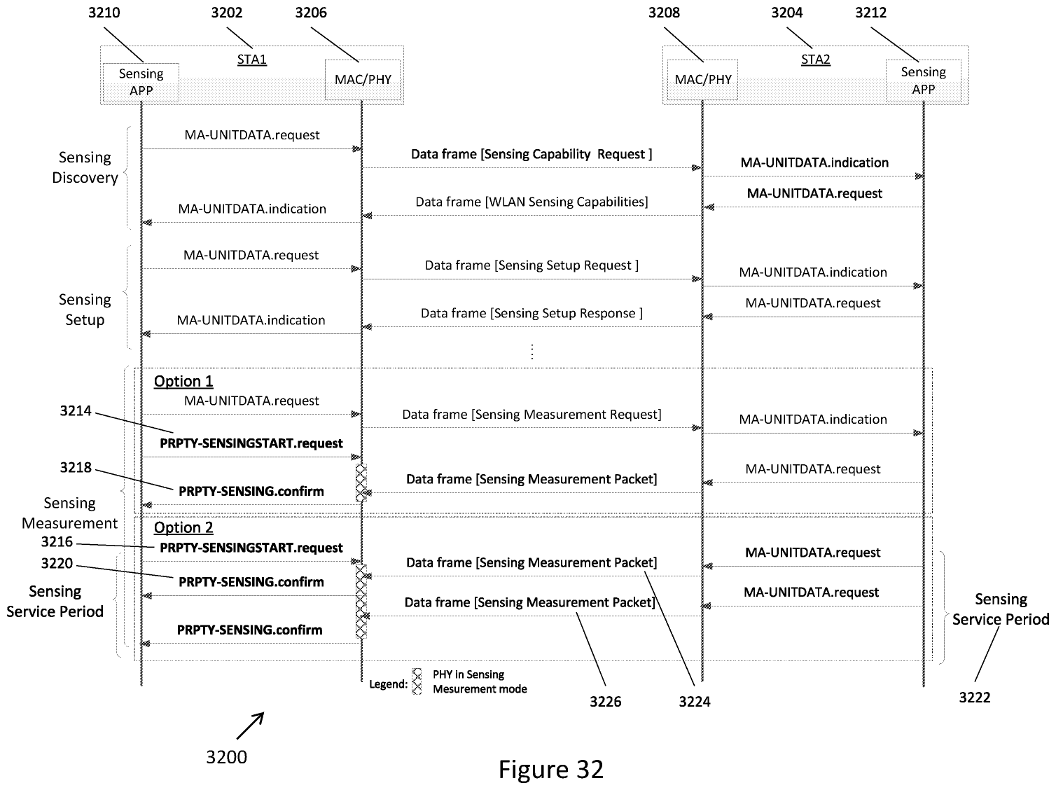

FIG. 32 depicts an illustration 3200 of a sensing measurement process in accordance with the third embodiment. In this example, all sensing related signalling are either carried in Data frames to a remote peer STA (e.g. STA1 3202 or STA2 3204) or passed to a local MAC via proprietary APIs. Sensing related operations are transparent to the 802.11 MAC/PHY (e.g. MAC/PHY 3206 and MAC/PHY 3208 respectively). This deployment may be the only option for devices that are not possible to be upgraded with 11bf related features. Two proprietary APIs may be provided by the MAC (MAC of MAC/PHY 3206 and MAC of MAC/PHY 3208 respectively) to the Sensing APP (Sensing APP 3210 and Sensing APP 3212 respectively):

1) PRPTY-SENSINGSTART.request (PRPTY-SENSINGSTART.request 3214 in an Option 1 or 3216 in an Option 2) is issued by the APP 3210 to the MAC to instruct the MAC/PHY 3206 to perform sensing measurements on any subsequently received PPDUs. Upon receiving the PRPTY-SENSINGSTART.request 3214 or 3216, the MAC switches the PHY to sensing measurement mode, e.g., by setting some hardware register to a known value.
2) PRPTY-SENSING.confirm (PRPTY-SENSING.confirm 3218 in the Option 1 or 3220 in the Option 2) is issued by the MAC/PHY 3206 to forward the results of the sensing measurements (e.g., CSI) to the Sensing APP 3210. In some implementation, the sensing measurements may be passed to the App 3210 by appending it to the payload of a received data frame, or even replacing a payload of a Data frame with the sensing measurement results.

Further, if Sensing SPs have been negotiated (e.g. Sensing SP 3222 in the Option 2), Sensing Measurement Requests may advantageously be omitted and the Sensing Transmitter (e.g. STA2 3204) directly proceeds to transmit Sensing Measurement Packets (e.g. Sensing Measurement Packets 3224 and 3226) at the start of the Sensing SP 3222, while the Sensing Initiator (e.g. STA2 3202) places its PHY in the sensing measurement mode at the start of the Sensing SP 3222.

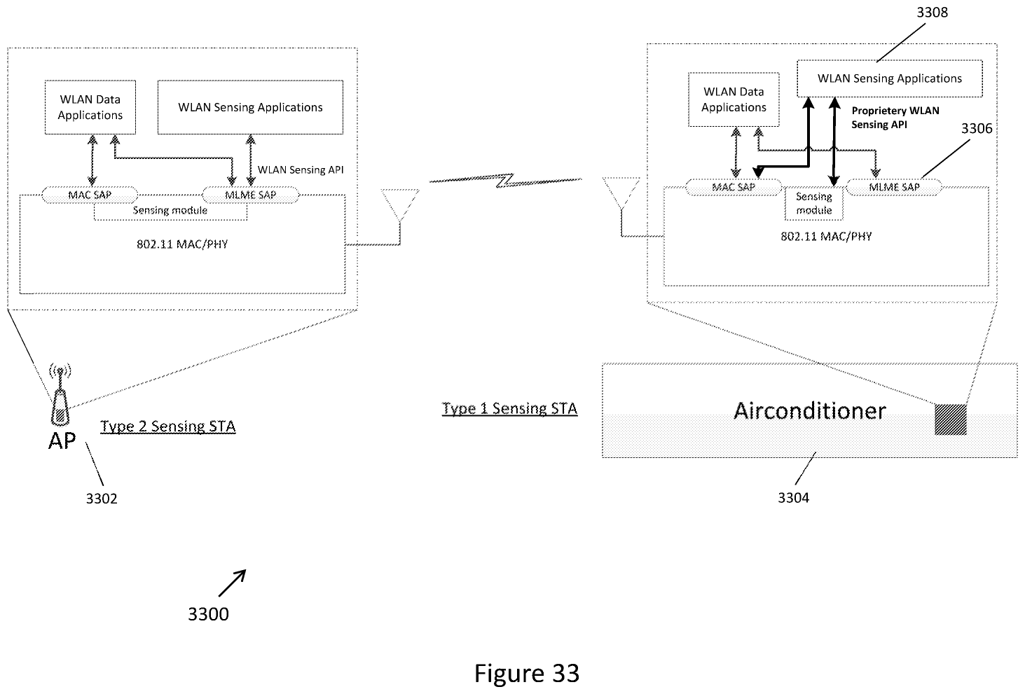

In a fourth embodiment E4, referring to illustration 3300 of FIG. 33, deployments with a Type 2 STA (e.g. AP 3302 being a Type 2 Sensing STA) and a Type 1 STA (e.g. Air conditioner 3304 being a Type 1 Sensing STA) are considered. The Type 1 STA 3304 supports minimal changes to the MAC and MAC-PHY interfaces and most of the WLAN Sensing intelligence is assumed to be maintained in WLAN Sensing application 3308 that sits above the MAC. No changes are made to the MLME SAP 3306 (Management plane). Sensing Measurements are performed using Sensing Application commands carried in Ethertype 89-0d Data frames and via proprietary WLAN Sensing API (for Type 1 STA 3304) e.g. a measurement request frame may be an Ethertype 89-0d Data frame.

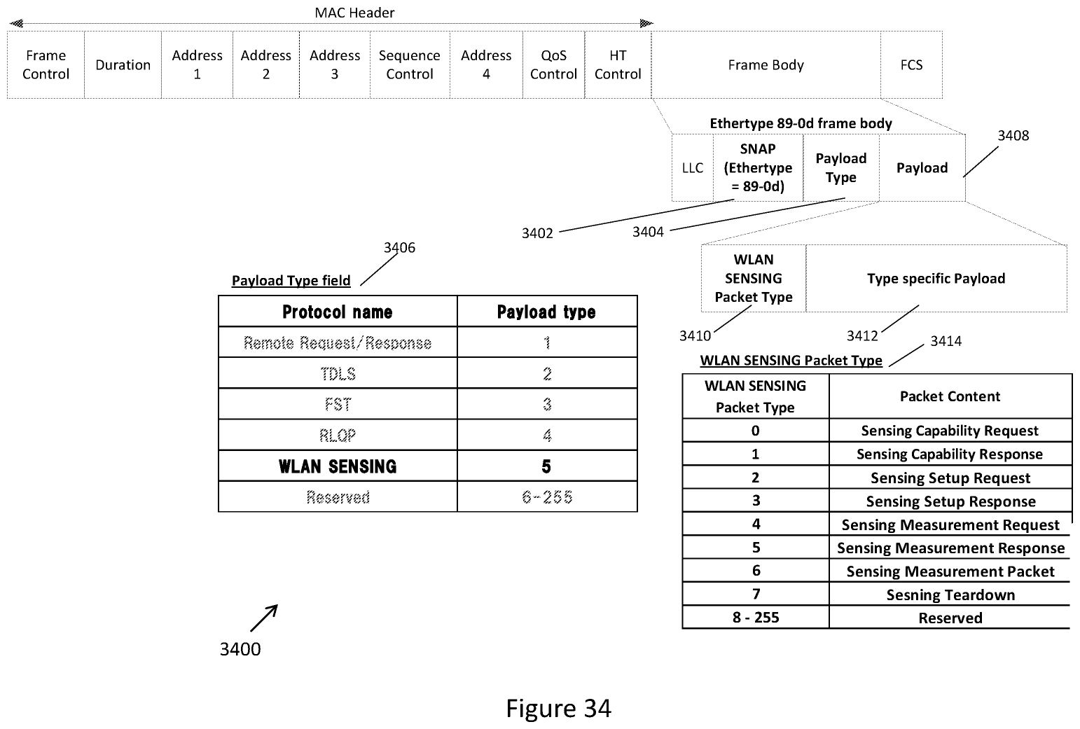

FIG. 34 depicts an illustration of an Ethertype 89-0d frame 3400 in accordance with the fourth embodiment. The Ethertype 89-0d frame 3400 is a 802.11 Data frame in which an Ethertype subfield (not shown) of a Subnetwork Access Protocol (SNAP) field 3402 is set as 89-0d (IEEE Std 802.11). A Measurement Request frame may be transmitted as payload of the Ethertype 89-0d frame 3400. The main difference between utilizing an Ethertype 89-0d frame and a normal 802.11 Data frame is that 802.11 MAC can understand Ethertype 89-0d frames, so Sensing Measurements may be performed using Sensing Application commands carried in Ethertype 89-0d Data frames. A Type 2 STA can understand WLAN SENSING Ethertype 89-0d frames but a Type 1 STAs may not if its MAC cannot be upgraded.

In a Payload Type field 3404 of Ethertype 89-0d frame 3400, a new Ethertype 89-0d Payload Type may be defined for WLAN Sensing e.g. Payload Type field 3404 may be set to ‘5’ to indicate WLAN Sensing as shown in Table 3406. Further, a Payload field 3408 may comprise a WLAN Sensing Packet Type field 3410 and Type specific Payload field 3412. WLAN Sensing Packet Type field 3410 may be set to any one of values 0-7 to indicate a packet type as shown in Table 3414, while Type specific Payload field 3412 may be used to carry additional parameters related to each WLAN SENSING Packet type shown in Table 3414. While the other WLAN SENSING Packets may carry Type specific payloads, the Sensing Measurement Packet may not include any payload since it is solely used to measure the channel based on the PHY preamble. It is also possible that instead of defining a WLAN SENSING packet for sensing measurement, any Data frame e.g., a QoS Null Data frame with ACK policy set to No Ack may be used as the sensing measurement packet instead.

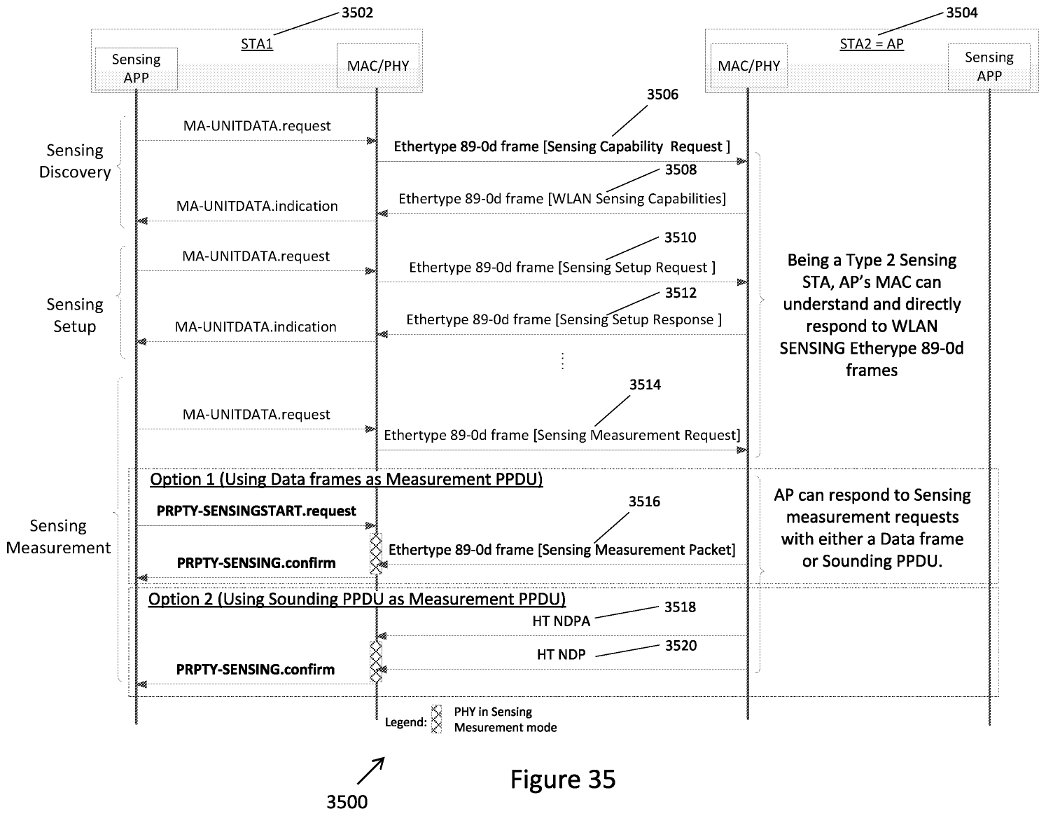

FIG. 35 depicts an illustration 3500 of an example WLAN sensing procedure between a Type 1 STA (STA1, a non-AP STA) as the Sensing Initiator and a Type 2 STA (STA2 which may be an AP or another non-AP STA) as the Sensing Responder in accordance with the fourth embodiment. In this example, STA1 3502 is a Type 1 STA with 11n PHY, while STA2 3504 is a Type 2 AP that can understand the WLAN SENSING Ethertype 89-0d frames at the MAC layer and hence can respond to them directly (without needed to forward them up to the Sensing APP). Further, STA1 3502 is the Sensing Initiator while STA2 3504 is the Sensing Responder.

Being a Type 2 sensing STA, MAC of the STA2 3504 can understand and directly respond to WLAN Sensing Ethertype 89-0d frames e.g. responding to Ethertype 89-0d frame (Sensing Capability Request) 3506 from STA1 3502 with an Ethertype 89-0d frame (WLAN Sensing Capabilities) 3508, and responding to Ethertype 89-0d frame (Sensing Setup Request) 3510 from STA1 3502 with an Ethertype 89-0d frame (Sensing Setup Response) 3512. Further, the STA2 3504 can also respond to Sensing Measurement requests (e.g. Ethertype 89-0d frame (Sensing Measurement request) 3414 from STA1 3502) with either a Data frame (e.g. Ethertype 89-0d frame (Sensing Measurement Packet) 3516 in an Option 1) or Sounding PPDU (e.g. HT NDP 3520 (and optionally HT NDPA 3518) in an Option 2).

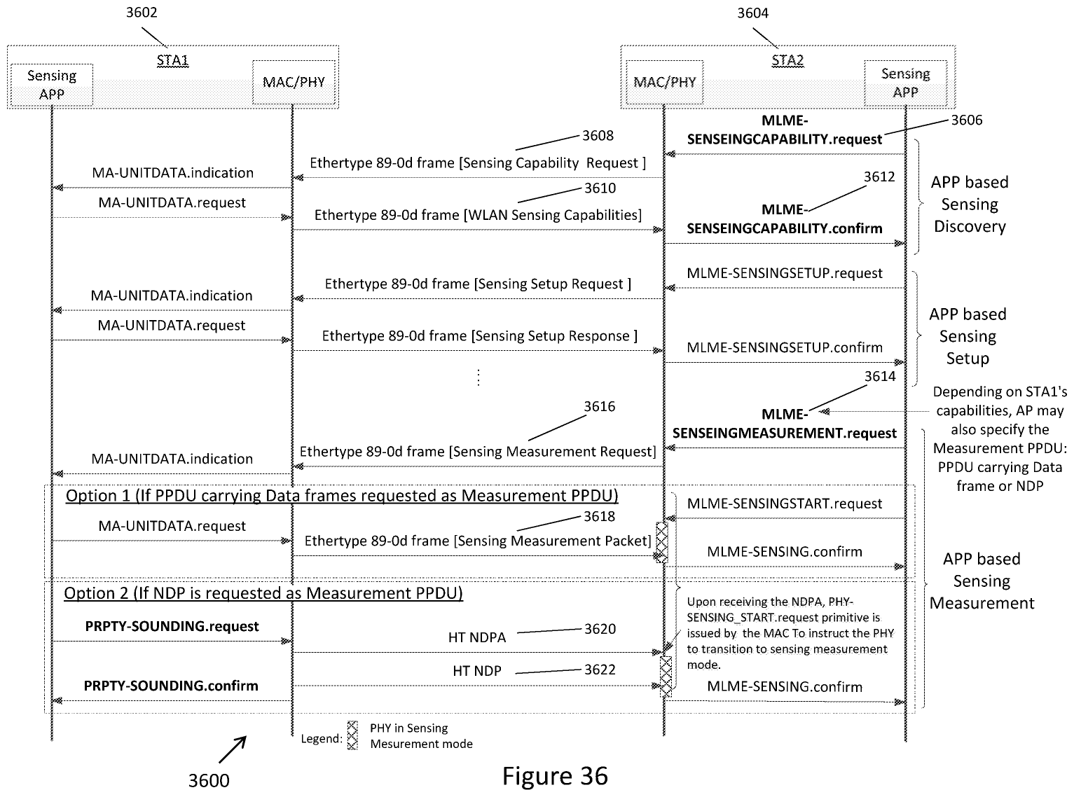

FIG. 36 depicts an illustration 3600 of an example WLAN sensing procedure between a Type 1 STA (STA1 3602) as the Sensing Responder and a Type 2 STA (Sensing Initiator STA2 3604) as the Sensing Initiator in accordance with the fourth embodiment. Similar to the earlier example of FIG. 35, STA1 3602 is a Type 1 STA with 11n PHY, while STA2 3604 is a Type 2 STA (either AP or non-AP) that can understand WLAN SENSING Ethertype 89-0d frames at MAC layer and hence can respond to them directly (e.g. without needing to forward them up to Sensing APP). In this example, STA2 3604 is the Sensing Initiator. In this case, since STA1 3602 is a non-AP STA, it does not transmit Beacon frames and if the MAC is not upgraded with 11bf discovery protocols, it also may not include WLAN Sensing capabilities in its MAC frames (e.g., in Association Request or Probe Request frames). In such case, dedicated MLMEs may be defined in 11bf in order to discover such Type 1 STAs. For example, MLME-SENSINGCAPABILITY.request primitive 3606 is used by APP of STA2 3604 to instruct the 11bf MAC of STA2 3604 to transmit the frame used to solicit WLAN Sensing capabilities from a peer STA (e.g. STA1 3602), such as a WLAN Sensing Ethertype 89-0d frame (Sensing Capability Request) 3608, and a MLME-SENSINGCAPABILITY.confirm primitive 3612 is issued by the 11bf MAC of STA2 3604 to pass the discovered WLAN Sensing capabilities (e.g. from Ethertype 89-0d frame (WLAN Sensing Capabilities) 3610 transmitted from STA1 3602) to the APP of STA2 3604. If the WLAN Sensing capabilities indicate that STA1 is capable of Solicited Measurements, MLME-SENSINGMEASUREMENT.request primitive 3614 is issued by the APP of STA2 3604 to instruct the 11bf MAC of STA2 3604 to transmit a Sensing Measurement Request frame (e.g. Ethertype 89-0d frame (Sensing Measurement Request) 3616) to STA1 3602 to solicit measurement PPDU to be used for WLAN sensing. The MLME-SENSINGMEASUREMENT.request primitive 3614 (and the transmitted Sensing Measurement Request frame 3616) indicates to STA1 3602 the type of PPDU that is solicited. If STA1 3602 indicated support for NDP measurement PPDU, its MAC/PHY may support proprietary APIs that may be used to trigger the transmission of NDPA/NDPs (e.g. HT NDPA 3620 and HT NDP 3622 in an Option 2), else it may transmit an Ethertype 89-0d Data frame as the measurement PPDU (e.g. Ethertype 89-0d frame (Sensing Measurement Packet) 3618 in an Option 1). With these two examples, it can be seen that even if a Type 1 STA (e.g., an 0.11 device with legacy PHY) doesn't support any 11bf MAC/PHY features, with minimal/no proprietary APIs, such STAs may still advantageously be able to participate in WLAN Sensing.

For E2-E4, most of the examples given were for sensing between an AP and a non-AP STA. When both STAs of the sensing STA pair are non-AP STAs, it may not be possible to transmit the Data frames used to carry the Sensing App's commands or the WLAN SENSING Ethertype frames directly to the peer STA (unless the two non-AP STAs have already negotiated peer to peer protocols such as Tunnelled Direct Link Setup (TDLS)). In such cases, the Data frames may be forwarded to the peer STA via the common associated AP (called AP path), i.e., the initiating non-AP STA transmits the Data frame to the AP with the Address 3 (DA) set as the MAC address of the destination non-AP STA. The only exception is the Data frame used as the Measurement PPDU, which is transmitted directly (called direct path) to the peer STA (i.e., the Address 1 (RA) is set as the non-AP STA's MAC Address). It is also possible that the response frame used during Sensing discovery may be defined to be a public management Action frame which is transmitted to the peer non-AP STA via the direct path. This may be done to let the initiator estimate whether the peer STA (responder) that is being discovered is within its coverage range and whether the direct link is suitable for WLAN sensing purpose.

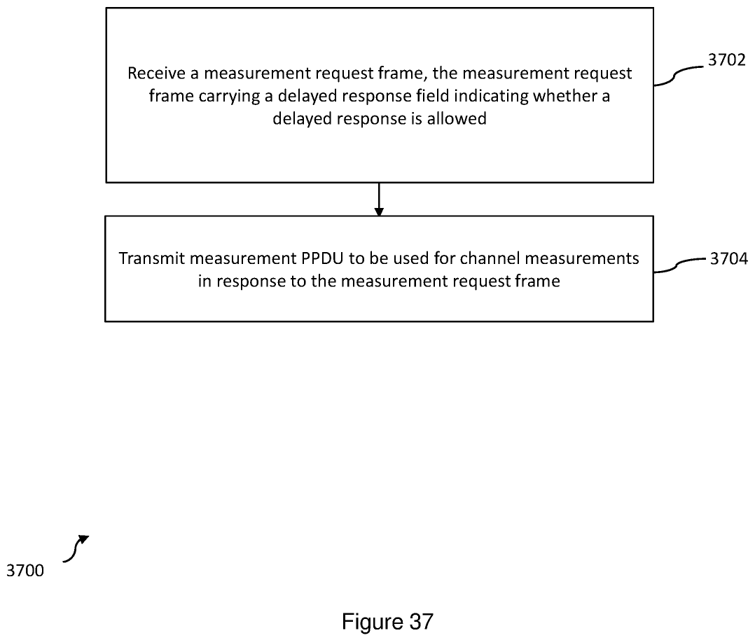

FIG. 37 shows a flow diagram 3700 illustrating a communication method according to various embodiments. At step 3702, a measurement request frame is received, the measurement request frame carrying a delayed response field indicating whether a delayed response is allowed. At step 3704, a measurement PPDU is transmitted to be used for channel measurements in response to the measurement request frame.

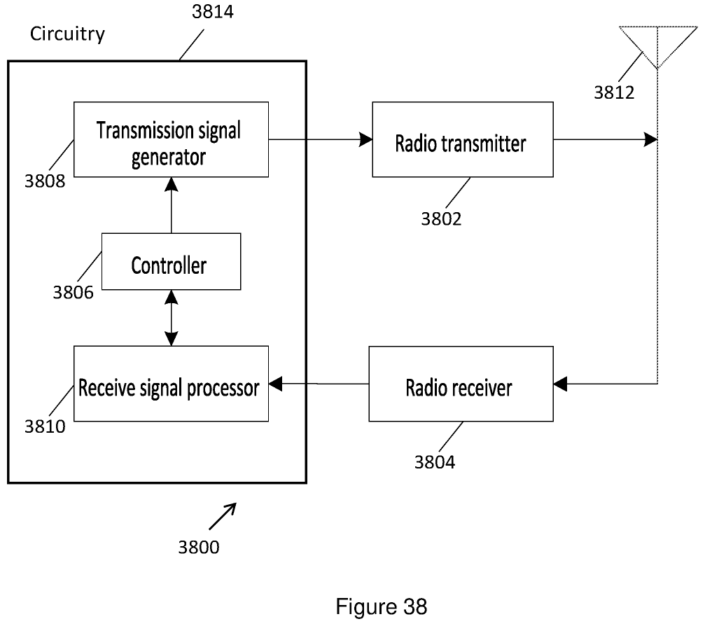

FIG. 38 shows a schematic, partially sectioned view of a communication apparatus 3800 that can be implemented for low complexity WLAN sensing in accordance with the first to fourth embodiments. The communication apparatus 3800 may be implemented as an STA or AP according to various embodiments.

Various functions and operations of the communication apparatus 3800 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 38, the communication apparatus 3800 may include circuitry 3814, at least one radio transmitter 3802, at least one radio receiver 3804 and multiple antennas 3812 (for the sake of simplicity, only one antenna is depicted in FIG. 38 for illustration purposes). The circuitry may include at least one controller 3806 for use in software and hardware aided execution of tasks it is designed to perform, including control of communications with one or more other multi-link devices in a MIMO wireless network. The at least one controller 3806 may control at least one transmission signal generator 3808 for generating frames to be sent through the at least one radio transmitter 3802 to one or more other STAs or APs and at least one receive signal processor 3810 for processing frames received through the at least one radio receiver 3804 from the one or more other STAs or APs. The at least one transmission signal generator 3808 and the at least one receive signal processor 3810 may be stand-alone modules of the communication apparatus 3800 that communicate with the at least one controller 3806 for the above-mentioned functions. Alternatively, the at least one transmission signal generator 3808 and the at least one receive signal processor 3810 may be included in the at least one controller 3806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3802, at least one radio receiver 3804, and at least one antenna 3812 may be controlled by the at least one controller 3806. Furthermore, while only one radio transmitter 3802 is shown, it will be appreciated that there can be more than one of such transmitters.

In various embodiments, when in operation, the at least one radio receiver 3804, together with the at least one receive signal processor 3810, forms a receiver of the communication apparatus 3800. The receiver of the communication apparatus 3800, when in operation, provides functions required for sensing operations. While only one radio receiver 3804 is shown, it will be appreciated that there can be more than one of such receivers.

The communication apparatus 3800, when in operation, provides functions required for low complexity WLAN sensing. For example, the communication apparatus 3800 may be a first communication apparatus. The receiver 3804 may, in operation, receive a measurement request frame from a second communication apparatus, the measurement request frame carrying a delayed response field indicating whether a delayed response is allowed. The transmitter 3802 may, in operation, transmit a measurement PPDU to be used for channel measurements in response to the measurement request frame.

The transmitter 3802 may be further configured to transmit the measurement PPDU in a next transmission opportunity when the delayed response field indicates that a delayed response is allowed. The circuitry 3814 may, in operation, generate an announcement frame prior to transmitting the measurement PPDU, wherein the announcement frame may be a VHT, HE or EHT NDPA frame addressed to the second communication apparatus, the NDPA frame carrying a STA Info field with the AID12 field set to a known AID value to indicate that the second communication apparatus is not expected to transmit a feedback frame. The transmitter 3802 may be further configured to transmit the announcement frame within a fixed duration prior to transmitting the measurement PPDU.

The circuitry 3814 may, in operation, when the delayed response field indicates that delayed response is not allowed and the measurement request frame further carries a padding field, detect a start of the padding field, and the transmitter 3802 may be further configured to transmit, in response to the detection, the measurement PPDU within a fixed duration after the measurement request frame is received. The padding field may further carry a CRC that is calculated based on contents of the measurement request frame.

The receiver 3804 may be further configured to receive the measurement request frame as payload of an 802.11 Data frame, the 802.11 Data frame comprising a SNAP field including an Ethertype subfield, wherein the Ethertype subfield is set as 89-0d. The first communication apparatus 3800 may be further configured to advertise itself as being one of a Type 1 or Type 2 device, the Type 1 device being of lesser capability than the Type 2 device; wherein the delayed response field is set to indicate that delayed response is allowed if the first communication apparatus 3800 is a Type 1 device, and set to indicate that delayed response is not allowed if the first communication apparatus 3800 is a Type 2 device. The first communication apparatus 3800 may be further configured to advertise a Response Delay, wherein the Response Delay is set to zero to indicate that the first communication apparatus 3800 is able to transmit a measurement PPDU within a SIFS of receiving a measurement request frame, or set to a non-zero value otherwise. The transmitter 3802 may be further configured to transmit the measurement PPDU as one of a NDP or any 802.11 PPDU carrying a Data frame. The first communication apparatus 3800 may be further configured to advertise whether it is capable of transmitting a measurement PPDU upon receiving a Measurement request frame and, if it is advertised to be capable of doing so, further advertise a type of measurement PPDU that it is capable of transmitting, the type of measurement PPDU being a NDP or an 802.11 PPDU carrying a Data frame.

The first communication apparatus 3800 may be further configured to negotiate with the second communication apparatus, during a setup phase, one or more time windows in which to perform a sensing measurement. The one or more time windows being negotiated may be scheduled S-APSD SPs. The one or more time windows being negotiated may be TWT SPs.

The measurement request frame may be a Data frame carrying a measurement request Sensing Application command. The measurement request frame may be an Ethertype 89-0d Data frame. For example, the communication apparatus 3800 may be the second communication apparatus. The receiver 3804 may, in operation, receive information relating to the first communication apparatus. The circuitry 3814 may, in operation, generate a measurement request frame based on the information, the measurement request frame carrying a delayed response field indicating whether a delayed response is allowed. The transmitter 3802 may, in operation, transmit a measurement request frame to the first communication apparatus. The information may indicate a response delay, the Response Delay being set to zero to indicate that the first communication apparatus is able to transmit a measurement PPDU within a SIFS of receiving a measurement request frame; the Response Delay being set to a non-zero value otherwise; and wherein the circuitry 3814 may be further configured to categorise the first communication apparatus as a Type 2 device if the Response Delay is set to zero and as a Type 1 device if the Response Delay is set to a non-zero value, and set the delayed response field to indicate that delayed response is allowed if the first communication apparatus is categorized as a Type 1 device, and set to indicate that delayed response is not allowed if the first communication apparatus is categorized as a Type 2 device. The information may indicate a PHY of the first communication apparatus, and wherein the circuitry 3814 may be further configured to categorise the first communication apparatus as a Type 1 device if the PHY is based on 802.11n or 802.11ac, and as a Type 2 device if the PHY is based on 802.11ax or 802.11be; and set the delayed response field to indicate that delayed response is allowed if the first communication apparatus is categorized as a Type 1 device, and set to indicate that delayed response is not allowed if the first communication apparatus is categorized as a Type 2 device.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for low complexity WLAN sensing.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus comprising:
a receiver, which in operation, receives a measurement request frame from a second communication apparatus, the measurement request frame carrying a delayed response field indicating whether a delayed response is allowed; and
a transmitter, which in operation, transmits a measurement Physical Protocol Data Unit (PPDU) to be used for channel measurements in response to the measurement request frame.

2. The first communication apparatus according to claim 1, wherein the transmitter is further configured to transmit the measurement PPDU in a next transmission opportunity when the delayed response field indicates that a delayed response is allowed.

3. The first communication apparatus according to claim 1, further comprising:
circuitry, which in operation, when the delayed response field indicates that delayed response is not allowed and the measurement request frame further carries a padding field, detects a start of the padding field; and
wherein the transmitter is further configured to transmit, in response to the detection, the measurement PPDU within a fixed duration after the measurement request frame is received.

4. The first communication apparatus according to claim 3, wherein the padding field further carries a cyclic redundancy code (CRC) that is calculated based on contents of the measurement request frame.

5. The first communication apparatus according to claim 2, further comprising circuitry, which in operation, generates an announcement frame prior to transmitting the measurement PPDU, wherein the announcement frame is a Very High Throughput (VHT), High Efficiency (HE) or Extremely High Throughput (EHT) null data packet announcement (NDPA) frame addressed to the second communication apparatus, the NDPA frame carrying a STA Info field with the AID12 field set to a known association identifier (AID) value to indicate that the second communication apparatus is not expected to transmit a feedback frame.

6. The first communication apparatus according to claim 5, wherein the transmitter is further configured to transmit the announcement frame within a fixed duration prior to transmitting the measurement PPDU.

7. The first communication apparatus according to claim 1, wherein the receiver is further configured to receive the measurement request frame as payload of an 802.11 Data frame, the 802.11 Data frame comprising a Sub-Network Access Protocol (SNAP) field including an Ethertype subfield, wherein the Ethertype subfield is set as 89-0d.

8. The first communication apparatus according to claim 1, further configured to advertise itself as being one of a Type 1 or Type 2 device, the Type 1 device being of lesser capability than the Type 2 device; wherein the delayed response field is set to indicate that delayed response is allowed if the first communication apparatus is a Type 1 device, and set to indicate that delayed response is not allowed if the first communication apparatus is a Type 2 device.

9. The first communication apparatus according to claim 1, further configured to advertise a Response Delay, wherein the Response Delay is set to zero to indicate that the first communication apparatus is able to transmit a measurement PPDU within a short interframe space (SIFS) of receiving a measurement request frame, or set to a non-zero value otherwise.

10. The first communication apparatus according to claim 1, wherein the transmitter is further configured to transmit the measurement PPDU as one of a Null Data Packet (NDP) or any 802.11 PPDU carrying a Data frame.

11. The first communication apparatus according to claim 1, further configured to advertise whether it is capable of transmitting a measurement PPDU upon receiving a Measurement request frame and, if it is advertised to be capable of doing so, further advertise a type of measurement PPDU that it is capable of transmitting, the type of measurement PPDU being a NDP or an 802.11 PPDU carrying a Data frame.

12. The first communication apparatus according to claim 1, further configured to negotiate with the second communication apparatus, during a setup phase, one or more time windows in which to perform a sensing measurement.

13. The first communication apparatus according to claim 12, wherein the one or more time windows being negotiated are scheduled automatic power save delivery (S-APSD) service periods (SP).

14. The first communication apparatus according to claim 12, wherein the one or more time windows being negotiated are Target Wait Time (TWT) service periods (SP).

15. The first communication apparatus according to claim 1, wherein the measurement request frame is a Data frame carrying a measurement request Sensing Application command.

16. The first communication apparatus according to claim 1, wherein the measurement request frame is an Ethertype 89-0d Data frame.

17. A second communication apparatus, comprising:
a receiver, which in operation, receives information relating to a first communication apparatus;
circuitry, which in operation, generates a measurement request frame based on the information, the measurement request frame carrying a delayed response field indicating whether a delayed response is allowed; and
a transmitter, which in operation, transmits a measurement request frame to the first communication apparatus.

18. The second communication apparatus according to claim 17, wherein the information indicates a response delay, the Response Delay being set to zero to indicate that the first communication apparatus is able to transmit a measurement PPDU within a SIFS of receiving a measurement request frame; the Response Delay being set to a non-zero value otherwise; and wherein the circuitry is further configured to:
categorise the first communication apparatus as a Type 2 device if the Response Delay is set to zero and as a Type 1 device if the Response Delay is set to a non-zero value; and
set the delayed response field to indicate that delayed response is allowed if the first communication apparatus is categorized as a Type 1 device, and set to indicate that delayed response is not allowed if the first communication apparatus is categorized as a Type 2 device.

19. The second communication apparatus according to claim 17, wherein the information indicates a PHY of the first communication apparatus, and wherein the circuitry is further configured to:
categorise the first communication apparatus as a Type 1 device if the PHY is based on 802.11n or 802.11ac, and as a Type 2 device if the PHY is based on

802. 11ax or 802.11be; and
set the delayed response field to indicate that delayed response is allowed if the first communication apparatus is categorized as a Type 1 device, and set to indicate that delayed response is not allowed if the first communication apparatus is categorized as a Type 2 device.

20. A communication method comprising:
receiving a measurement request frame from a communication apparatus, the measurement request frame carrying a delayed response field indicating whether a delayed response is allowed; and
transmitting a measurement Physical Protocol Data Unit (PPDU) to be used for channel measurements in response to the measurement request frame.
